(19) United States
(12) Patent Application Publication
(10) Pub. No.: US 2025/0100111 A1
(43) Pub. Date: Mar. 27, 2025

(54) IMPACT TOOL

(71) Applicant: Nanjing Chervon Industry Co., Ltd., Nanjing (CN)

(72) Inventors: Zhipeng Li, Nanjing (CN); Hongtao Ke, Nanjing (CN); Feng Li, Nanjing (CN); Zhiwei Feng, Nanjing (CN)

(21) Appl. No.: 18/816,202

(22) Filed: Aug. 27, 2024

(30) Foreign Application Priority Data
Sep. 27, 2023 (CN) 202311270632.5

(51) Int. Cl. B25B 21/02; B25F 5/00; B25F 5/02

(52) U.S. Cl. CPC B25B 21/02; B25F 5/006; B25F 5/026

(57) ABSTRACT

A impact tool includes a motor including a stator and a rotor, where the rotor is formed on or connected to a drive shaft that rotates about a first axis; a first handle disposed at an end of a housing facing away from an output shaft along the direction of the first axis; and a direct current (DC) power supply including at least two battery packs and supported on the housing, where along the direction of the first axis, the DC power supply at least partially overlaps the motor.

### RELATED APPLICATION INFORMATION

This application claims the benefit under 35 U.S.C. § 119 (a) of Chinese Patent Application No. 202311270632.5, filed on Sep. 27, 2023, which application is incorporated herein by reference in its entirety.

### TECHNICAL FIELD

The present application relates to a power tool and, in particular, to an impact tool.

### BACKGROUND

An impact tool refers to a tool capable of outputting rotary motion at a certain impact frequency. Common impact tools include an impact wrench, an impact screwdriver, an impact drill, and the like. The impact wrench is generally used for screwing bolts, nuts, and the like. The impact screwdriver is generally used for loosening or tightening screws and the like. The impact drill is generally used for drilling a hole through an impact.

To output the rotary motion at a certain impact frequency, the impact tool generally includes an output assembly for outputting a rotary force and an impact assembly for periodically impacting the output assembly. In the related art, when nuts on vehicle tires are detached or mounted or during railway construction, the used impact wrench is required to have a relatively large output torque, and correspondingly, the impact wrench is relatively heavy and often weighs more than 10 kg. Therefore, the component arrangement of the impact wrench is required to adapt to the usage of the operator.

This part provides background information related to the present application. The background information is not necessarily the existing art.

### SUMMARY

An impact tool includes a motor including a stator and a rotor, where the rotor is formed on or connected to a drive shaft that rotates about a first axis; an output shaft used for outputting torque and rotating about an output axis; an impact assembly, where the motor is drivingly connected to the impact assembly, the impact assembly is configured to apply an impact force to the output shaft, the impact assembly includes an impact block driven by the drive shaft and a hammer anvil for receiving an impact from the impact block, and the output shaft is formed on or connected to the hammer anvil; and a housing extending basically along the direction of the first axis, where the motor and the impact assembly are at least partially disposed in the housing. The impact tool further includes a first handle disposed at an end of the housing facing away from the output shaft along the direction of the first axis; and a direct current (DC) power supply including at least two battery packs and supported on the housing, where along the direction of the first axis, the DC power supply at least partially overlaps the motor.

In some examples, the DC power supply at least partially overlaps the stator of the motor.

In some examples, the at least two battery packs are supported on two sides of the housing.

In some examples, the at least two battery packs are symmetrically supported on the two sides of the housing with the first axis as a central axis.

In some examples, two battery packs of the at least two battery packs at least partially overlap the stator of the motor separately along the direction of the first axis.

In some examples, the at least two battery packs are disposed on a lower side of the housing separately.

In some examples, the housing is formed with or connected to power supply mounting portions, and the two battery packs enter the power supply mounting portions along a first direction and a second direction, respectively, where the included angle between the first direction and the second direction is greater than 0 degrees.

In some examples, the first handle includes a first opening for accommodating fingers, and the first opening includes a through hole that completely surrounds the fingers.

In some examples, the first handle includes a first opening for accommodating fingers and a second opening whose opening direction intersects with the opening direction of the first opening.

In some examples, the first handle includes a connection portion and a grip extending along a third direction, where an end of the grip is connected to the housing through the connection portion, and the other end of the grip is a free end.

In some examples, the first handle is provided with a power switch for turning on and off the motor, where the switch is disposed on the grip.

In some examples, the third direction intersects with the direction of the first axis.

In some examples, the nominal capacity of a battery pack of the at least two battery packs is greater than or equal to 5 Ah.

In some examples, the housing includes an output housing and a motor housing, the output housing supports the output shaft, the motor is at least partially supported in the motor housing, the output housing is connected to the motor housing, and a second handle is connected to the output housing.

In some examples, at least one of the first handle and the second handle is adjustable.

An impact tool includes a motor including a drive shaft that rotates about a first axis; an output shaft used for outputting torque and rotating about an output axis; an impact assembly, where the motor is drivingly connected to the impact assembly, the impact assembly is configured to apply an impact force to the output shaft, the impact assembly includes an impact block driven by the drive shaft and a hammer anvil for receiving an impact from the impact block, and the output shaft is formed on or connected to the hammer anvil; and a housing extending basically along the direction of the first axis, where the motor and the impact assembly are at least partially disposed in the housing. The impact tool further includes a first handle disposed at an end of the housing facing away from the output shaft along the direction of the first axis; and a DC power supply supported on the housing and disposed on the left side and/or the right side of the housing, where along the direction of the first axis, the DC power supply at least partially overlaps the motor.

An impact tool includes a motor including a drive shaft that rotates about a first axis; an output shaft used for outputting torque and rotating about an output axis; an impact assembly, where the motor is drivingly connected to the impact assembly, the impact assembly is configured to apply an impact force to the output shaft, the impact assembly includes an impact block driven by the drive shaft and a hammer anvil for receiving an impact from the impact block, and the output shaft is formed on or connected to the hammer anvil; and a housing extending basically along the direction of the first axis, where the motor and the impact assembly are at least partially disposed in the housing. The impact tool further includes a first handle disposed on the housing, where the first handle is provided with a power switch for turning on and off the motor; and a DC power supply including at least two battery packs and supported on the housing, where along the direction of the first axis, the first handle at least partially overlaps the DC power supply.

In some examples, the first handle further includes a grip, the power switch is disposed on the grip, the grip is provided with a grip part on the downstream side of the power switch, and along the direction of the first axis, the grip part at least partially overlaps the DC power supply.

In some examples, the at least two battery packs are symmetrically supported on two sides of the housing with the first axis as a central axis.

In some examples, the motor includes a stator and a rotor, the rotor is formed on or connected to the drive shaft that rotates about the first axis, and the at least two battery packs are behind the stator.

An impact tool includes a motor including a stator and a rotor, where the rotor is formed on or connected to a drive shaft that rotates about a first axis; an output shaft used for outputting torque and rotating about an output axis; an impact assembly, where the motor is drivingly connected to the impact assembly, the impact assembly is configured to apply an impact force to the output shaft, the impact assembly includes an impact block driven by the drive shaft and a hammer anvil for receiving an impact from the impact block, and the output shaft is formed on or connected to the hammer anvil; and a housing extending basically along the direction of the first axis, where the motor and the impact assembly are at least partially disposed in the housing. The impact tool further includes a first handle disposed at an end of the housing facing away from the output shaft along the direction of the first axis; and a DC power supply supported on the housing, where along the direction of the first axis, the DC power supply is disposed between the first handle and the output shaft; and the first handle is rotatably connected to the housing about a handle axis, the first handle is provided with a first opening for accommodating fingers, and the opening direction of the first opening is parallel to the direction of the handle axis.

An impact tool includes a motor including a stator and a rotor, where the rotor is formed on or connected to a drive shaft that rotates about a first axis; an output shaft used for outputting torque and rotating about an output axis; an impact assembly, where the motor is drivingly connected to the impact assembly, the impact assembly is configured to apply an impact force to the output shaft, the impact assembly includes an impact block driven by the drive shaft and a hammer anvil for receiving an impact from the impact block, and the output shaft is formed on or connected to the hammer anvil; and a housing extending basically along the direction of the first axis, where the housing includes an output housing and a motor housing, the output housing supports the output shaft, the motor is at least partially supported in the motor housing, and the output housing is connected to the motor housing. The impact tool further includes a first handle disposed at an end of the housing facing away from the output shaft along the direction of the first axis and surrounding at least the left side, the upper part, and the right side of the outer periphery of the housing; a second handle connected to the output housing and surrounding at least the left side, the upper part, and the right side of the outer periphery of the housing; and a third handle extending along the first axis and connected to the first handle and the second handle.

A power tool combination includes a power tool and an auxiliary device. The power tool includes a motor; and an output portion for outputting power. The auxiliary device includes a mechanical arm connected to the power tool and configured to adjust the power tool to a preset position; and a traveling mechanism for supporting the mechanical arm. The power tool combination further includes a power supply for supplying power to at least one of the power tool and the auxiliary device.

In some examples, the mechanical arm includes a first movement assembly and a second movement assembly connected to each other. One of the first movement assembly and the second movement assembly is supported by the traveling mechanism, and an output end of the other one of the first movement assembly and the second movement assembly is connected to the power tool. The first movement assembly is capable of driving the power tool to move, and the second movement assembly drives at least the power tool to rotate.

In some examples, the mechanical arm further includes a support frame supported by and connected to the traveling mechanism, the first movement assembly and the second movement assembly are connected to the support frame, and at least one of the first movement assembly or the second movement assembly include a drive motor for driving the first movement assembly and/or the second movement assembly.

In some examples, the second movement assembly provides at least two degrees of freedom (DOF) of rotary motion.

In some examples, the traveling mechanism includes a traveling wheel set, a base, and a traveling electric motor. The traveling wheel set is rotatably connected to the base, the mechanical arm is supported by the base, and the traveling electric motor drives the traveling wheel set to rotate.

In some examples, the traveling wheel set includes front wheels and rear wheels. The traveling electric motor drives the rear wheels. The front wheels are turning wheels.

In some examples, the front wheels are omni wheels.

In some examples, the traveling mechanism further includes a transmission mechanism, and the traveling electric motor is connected to the traveling wheel set through the transmission mechanism.

In some examples, the traveling mechanism further includes a speed regulation assembly. The speed regulation assembly is configured to adjust the traveling speed of the traveling wheel set.

In some examples, the auxiliary device further includes a frame body assembly. The frame body assembly forms a storage space.

In some examples, the power supply includes a first power supply disposed in the storage space; and/or the power tool can be stored in the storage space; and/or the auxiliary device further includes a storage box disposed in the storage space; and/or the auxiliary device further includes a deck box detachably connected to the frame body assembly and located on the outer side of the storage space.

In some examples, when the power supply includes the first power supply, the first power supply includes at least one battery pack, the storage space is further equipped with a charger, and the charger is configured to charge the at least one battery pack.

In some examples, the power supply includes the first power supply and a second power supply. The first power supply is configured to supply power to the mechanical arm and/or the traveling mechanism, and the second power supply is configured to supply power to the power tool.

In some examples, the auxiliary device further includes a light and/or an air pump for inflation.

In some examples, a control assembly is further included, and the power tool and the auxiliary device are communicatively connected to the control assembly separately.

In some examples, a human-machine interaction panel communicatively connected to the control assembly is further included.

An auxiliary device is used for assisting in changing the position of a power tool. The power tool includes a prime mover and an output portion, where the prime mover provides power for the output portion. The auxiliary device includes a mechanical arm connected to the power tool and configured to adjust the power tool to a preset position; and a traveling mechanism for supporting the mechanical arm. A power tool combination further includes a power supply for supplying power to at least one of the power tool and the auxiliary device.

An impact tool includes a motor including a drive shaft that rotates about a first axis; an output shaft used for outputting torque and rotating about an output axis; an impact assembly, where the motor is drivingly connected to the impact assembly, and the impact assembly is configured to apply an impact force to the output shaft; a housing, where the motor and the impact assembly are at least partially disposed in the housing; a first handle disposed at an end of the housing facing away from the output shaft; and a DC power supply, where the first handle is disposed between the DC power supply and the output shaft, and the DC power supply is supported by the first handle.

In some examples, the first handle is disposed between the DC power supply and the motor.

In some examples, a battery base is disposed at an end of the first handle facing away from the motor, and the DC power supply includes a battery pack detachably connected to the battery base.

In some examples, the DC power supply includes at least one battery pack.

A power tool includes a motor including a drive shaft that rotates about a first axis; an output shaft used for outputting torque and rotating about an output axis; a housing including a front cover housing that extends basically along the first axis and accommodates at least part of the motor; a rear cover housing mounted at an end of the front cover housing facing away from an output mechanism, where a first bearing seat is formed on or connected to the inner side surface of the rear cover housing, the first bearing seat is used for supporting a bearing at an end of the drive shaft facing away from the output shaft, and an accommodation space is formed on the outer side surface of the rear cover housing; and a circuit board assembly disposed in the accommodation space.

In some examples, the circuit board assembly includes a circuit board and an aluminum substrate.

In some examples, a fan is connected to the drive shaft of the motor and connected to the rear end of the motor.

In some examples, the motor includes a stator and a rotor assembly, the drive shaft is formed on or connected to the rotor assembly, and the fan is disposed between the stator and a first bearing.

In some examples, the circuit board assembly is disposed at the rear end of the fan.

In some examples, the front cover housing is cylindrical, and the rear cover housing is axially connected to the front cover housing.

In some examples, the rear cover housing is detachably connected to the front cover housing.

In some examples, axially protruding heat dissipation fins are disposed on the inner side of the rear cover housing.

In some examples, the heat dissipation fins are arranged circumferentially.

In some examples, the housing further includes a second cover connected to the rear cover housing and used for covering the opening of the rear cover housing.

### BRIEF DESCRIPTION OF THE DRAWINGS

FIG. 1 is a structural view of an impact tool according to an example of the present application.

FIG. 2 is a structural view of an impact tool according to an example of the present application from another perspective.

FIG. 3 is a sectional view of an impact tool according to an example of the present application.

FIG. 4 is a structural view of an impact tool according to another example of the present application.

FIG. 5 is a structural view of the impact tool in FIG. 4 from another perspective.

FIG. 6 is a structural view of an impact tool according to another example of the present application, where guide rails have different extension directions.

FIG. 7 is a structural view of an impact tool according to a third example of the present application.

FIG. 8 is a structural view of an impact tool according to a fourth example of the present application.

FIG. 9 is a structural view of the impact tool in FIG. 8 from another perspective.

FIG. 10 is a structural view of an impact tool according to a fifth example of the present application, where a first handle is at a first working position.

FIG. 11 is a structural view of an impact tool according to a fifth example of the present application, where a first handle is at a second working position.

FIG. 12 is a sectional view of some structures in FIG. 10.

FIG. 13 is an exploded view of some structures in FIG. 10.

FIG. 14 is a structural view of an impact tool according to a sixth example of the present application.

FIG. 15 is a structural view of the impact tool in FIG. 14 from another perspective.

FIG. 16 is a structural view of an impact tool according to a seventh example of the present application.

FIG. 17 is a structural view of another impact tool according to a seventh example of the present application.

FIG. 18 is a structural view of another impact tool according to a seventh example of the present application.

FIG. 19 is a structural view of another second handle of an impact wrench according to the present application.

FIG. 20 is an exploded view of another second handle of an impact wrench according to the present application.

FIG. 21 is a sectional view of another second handle of an impact wrench according to the present application.

FIG. 22 is a structural view of a third type of second handle of an impact wrench according to the present application.

FIG. 23 is a sectional view of a third type of second handle of an impact wrench according to the present application.

FIG. 24 is a sectional view of some structures of an impact wrench according to the present application.

FIG. 25 is a schematic view illustrating the arrangement of third fasteners and fourth fasteners of an impact wrench according to the present application.

FIG. 26 is a schematic view of a rear cover housing and fins of an impact wrench according to the present application.

FIG. 27 is a schematic view of a power tool combination according to an example of the present application from one perspective.

FIG. 28 is a schematic view of a power tool combination according to an example of the present application from another perspective.

FIG. 29 is a schematic view of a power tool combination according to an example of the present application, where the power tool combination is not provided with a protective cover.

FIG. 30 is a schematic view of a power tool combination according to another example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

To clearly illustrate the technical solutions of the present application, an upper side, a lower side, a left side, and a right side are defined in the drawings of the specification.

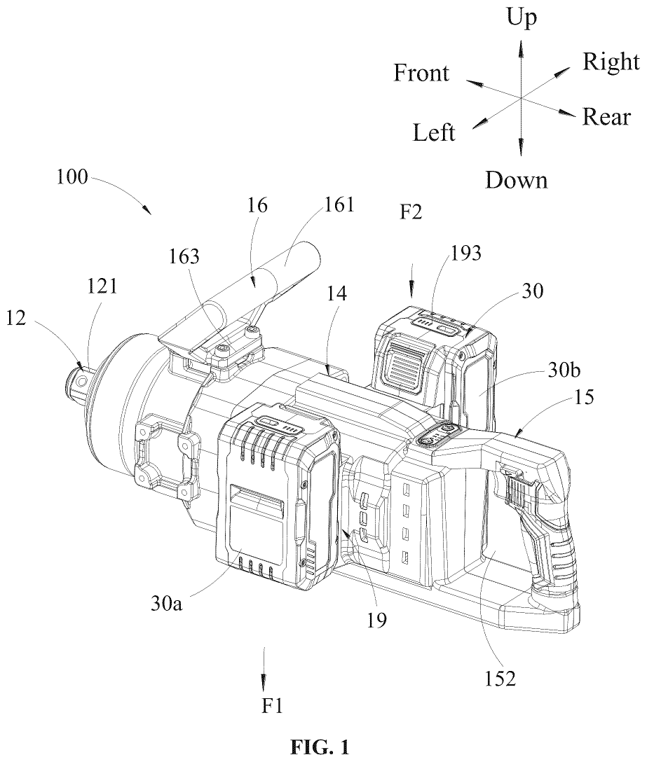

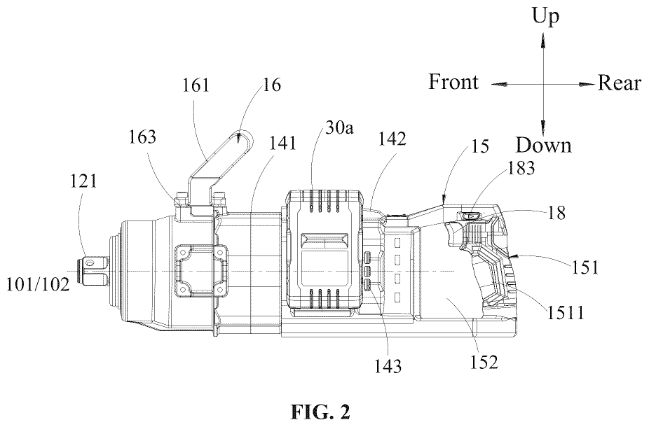

A power tool in the form of an impact tool or impact wrench 100 is shown in FIGS. 1 and 2. It is to be understood that in other alternative examples, different work attachments may be mounted to the impact tool. The impact tool with one of these different work attachments may be, for example, an impact screwdriver or an impact drill.

The impact wrench 100 includes a power supply. In this example, the power supply is a DC power supply 30. The DC power supply is used for supplying electrical energy to the impact wrench 100. The DC power supply is a battery pack, and the impact wrench 100 is powered by the battery pack in conjunction with a corresponding power supply circuit. It is to be understood by those skilled in the art that the power supply is not limited to the DC power supply, and the corresponding components in the machine may be powered through mains power or an alternating current (AC) power supply in conjunction with corresponding rectifier, filter, and voltage regulator circuits. In this example, the DC power supply is the battery pack. The power supply is replaced with a battery pack 30 below, which is not intended to limit the present invention.

In this example, the battery pack 30 may be a lithium battery pack, a solid-state battery pack, or a pouch battery pack. The battery pack includes a battery pack housing and single cells in the battery pack housing. The cells are rechargeable. Each cell has a nominal voltage between 3 volts and 5 volts. In some examples, the nominal voltage of a single battery pack 30 is greater than or equal to 8 V and less than or equal to 48 V. The battery pack may have a nominal capacity of at least 5 Ah (for example, a 5S2P battery pack having two strings of five cells connected in series) to improve the battery life. In some examples, the battery pack may have a nominal capacity of at least 9 Ah (for example, a 5S3P battery pack having three strings of five cells connected in series).

As shown in FIGS. 1 to 3, the impact wrench 100 includes a motor 11, an output mechanism 12, an impact assembly 13, a housing 14, and a first handle 15. The motor 11 includes a drive shaft that rotates about a first axis 101. The output mechanism includes an output shaft 121 that rotates about an output axis 102, and the output shaft 121 is used for outputting torque. The motor 11 is drivingly connected to the impact assembly 13, and the impact assembly 13 is configured to apply an impact force to the output shaft 121.

In this example, the motor 11 is specifically configured to be an electric motor. An electric motor 11 is used below instead of the motor, and a motor shaft 111 is used below instead of the drive shaft, which is not intended to limit the present application. In this example, the electric motor 11 may be a brushless DC electric motor (BLDC). The electric motor 11 includes a stator 115 and a rotor 116. The rotor 116 is formed on or connected to the motor shaft 111.

A clamping assembly is disposed at the front end of the output shaft 121 and can clamp corresponding work attachments, such as a screwdriver, a drill bit, and a sleeve, when different functions are implemented.

The output shaft 121 is used for outputting torque to the outside so that a fastener is operated. The output shaft 121 rotates about the output axis 102, where the first axis 101 coincides with the output axis 102 in this example. In other alternative examples, an included angle of a certain degree exists between the output axis 102 and the first axis 101. In other alternative examples, the first axis 101 and the output axis 102 are parallel to each other but do not coincide with each other.

The impact assembly 13 is used for applying an impact force to the output shaft 121. The impact assembly 13 includes a main shaft 131, an impact block 132 sleeved on the outer circumference of the main shaft, a hammer anvil 133 disposed at the front end of the impact block 132, and an elastic element 134. The hammer anvil 133 is connected to the output shaft 121. In this example, the hammer anvil 133 includes an anvil 135, and the output shaft 121 is formed at the front end of the anvil 135. It is to be understood that the anvil 135 and the output shaft 121 may be integrally formed or separately formed as independent parts.

With continued reference to FIGS. 1 to 3, the elastic element 134 provides a force for the impact block 132 to cause the impact block 132 to approach the hammer anvil 133. In this example, the elastic element 134 is a coil spring. A pair of first ball grooves that open forward and extend backward along the front and rear direction is provided on the front end surface of the impact block 132. A pair of second ball grooves is formed on the outer surface of the main shaft. The impact assembly 13 further includes rolling balls. The rolling balls straddle the first ball grooves and the second ball grooves so that the impact block 132 is connected to the main shaft. In this example, the rolling balls are steel balls.

The motor 11 and the impact assembly 13 are at least partially disposed in the housing 14. The housing 14 extends basically along the direction of the first axis 101. The first handle 15 is disposed at an end of the housing 14 facing away from the output shaft 121. Along the direction of the first axis 101, the first handle 15 and the housing 14 at least partially overlap and may be an integral structure or a split structure. The DC power supply includes at least two battery packs 30, and the DC power supply is supported on the housing 14. Along the direction of the first axis 101, the DC power supply 30 at least partially overlaps the motor 11. In this manner, the dimension of the whole formed by the DC power supply 30 and the motor 11 along the direction of the first axis 101 is less than the sum of the dimension of the DC power supply 30 along the direction of the first axis 101 and the dimension of the motor 11 along the direction of the first axis 101. Therefore, the length of the impact tool along the direction of the first axis 101 is reduced, and the structure is more compact. The first handle 15 is closer to the center of gravity of the impact tool 100. In this manner, the balance of the impact tool 100 is improved when an operator holds the first handle 15. For the convenience of reference, the DC power supply includes a first battery pack 30a and a second battery pack 30b.

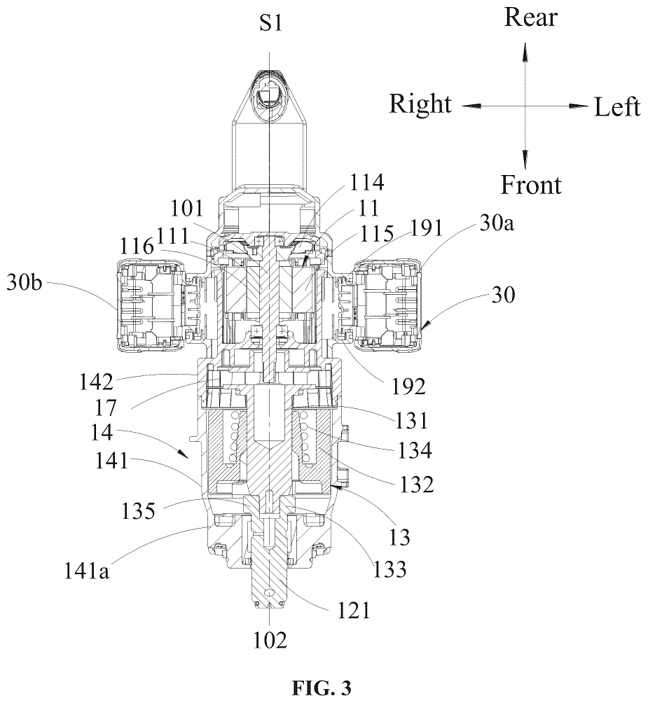

As shown in FIGS. 2 and 3, the DC power supply 30 at least partially overlaps the stator 115 of the electric motor 11 so that the DC power supply is as close to the first handle 15 as possible, and the center of gravity is moved backward so that the alignment of the output shaft 121 can be adjusted conveniently. For example, along the direction of the first axis 101, the first battery pack 30a and the second battery pack 30b at least partially overlap the stator 115 of the electric motor 11 separately.

In this example, the central axes of the electric motor 11 and the housing 14 extend in the same direction and are thus parallel to each other. Therefore, the motor shaft 111 of the electric motor 11 and the housing 14 both extend along the front and rear direction. In this example, the extension direction of the housing 14 is coaxial with the central axis of the motor shaft 111 so that the impact tool 100 has an in-line configuration.

In an example, the DC power supply is supported on the housing 14 and disposed on the left side and/or the right side of the housing 14. For example, the first battery pack 30a and the second battery pack 30b are disposed on the left side and the right side of the housing 14, respectively. In this example, a vertical plane passing through the first axis 101 is set as a central plane S1, and two sides of the central plane S1 are defined as the left side and the right side of the housing 14. The first battery pack 30a and the second battery pack 30b are disposed on the left side and the right side of the housing 14, respectively. It is to be understood that the first battery pack 30a is only located on the left side or right side of the housing 14, the second battery pack 30b is only located on the right side or left side of the housing 14, and neither the first battery pack 30a nor the second battery pack 30b straddles the left and right sides. Optionally, the first battery pack 30a and the second battery pack 30b are symmetrically supported on two sides of the housing 14 with the first axis 101 as a central axis.

The first handle 15 is substantially D-shaped, and the first handle 15 is at least partially connected to the housing 14. The first handle 15 includes a through hole that surrounds the fingers. In this example, the first handle 15 includes a first opening 152 for accommodating the fingers. The first opening 152 is an accommodation space that completely surrounds the fingers, that is to say, the first opening 152 is a closed hole. The connection between the housing 14 and the first handle 15 is a shock absorbing connection, which is comfortable to hold. For the shock absorbing connection, reference is made to the existing art, and the details are not repeated here. The first handle 15 is located at the rear of the housing 14 and is allowed for a user to push and pull directly relative to the impact wrench without generating rotational movement or torque between the first handle 15 and the housing 14. In this example, the first battery pack 30a and the second battery pack 30b are located in front of the first handle 15 separately. For example, the first battery pack 30a and the second battery pack 30b are at least partially located in front of the first handle 15 separately.

The impact wrench 100 further includes a power switch 18 and a switching portion 183. The power switch 18 is used for turning on and off the electric motor 11. For example, the power switch 18 is used for controlling the energized state of the electric motor 11. The switching portion 183 is disposed on the upper side of the power switch 18 and configured to be operated to cause the electric motor 11 to rotate in a forward rotation direction in which the fastener is fastened or screwed or a reverse rotation direction in which the fastener is loosened or unscrewed. In this example, the switching portion 183 is a toggle switch. The power switch 18 is disposed on the first handle 15. For example, the power switch 18 is disposed in the accommodation space of the first opening 152. In this example, the first handle 15 includes a grip 151, the power switch 18 is disposed on the grip 151, the grip 151 is provided with a grip part 1511 on the downstream side of the power switch 18, and the grip part 1511 is configured to support at least part of the palm when the user operates the power switch 18 with the fingers. The grip part 1511 is disposed on the downstream side of the power switch 18 along the extension direction.

As shown in FIGS. 2 and 3, a fan 114 is disposed at the rear side of the electric motor 11 and used for dissipating heat for the electric motor 11 and the impact wrench 100. The fan 114 is formed on or connected to the motor shaft 111. When the electric motor 11 rotates, the fan 114 rotates along with the electric motor 11. An air inlet 143 is provided on the housing 14 so that when the fan 114 rotates, the cooling air enters the housing 14 through the air inlet 143 to dissipate heat for the electric motor 11 and the impact wrench 100. In this example, the DC power supply 30 is disposed on the front side of the air inlet 143. For example, the DC power supply 30 and the air inlet 143 are staggered so that the DC power supply does not block the air inlet 143 at all.

The housing 14 includes an output housing 141 and a motor housing 142. The output housing 141 supports the output shaft 121. The electric motor 11 is at least partially supported in the motor housing 142. The output housing 141 is connected to the motor housing 142. In this example, the first handle 15 is formed on or connected to the motor housing 142. It is to be understood that the motor housing 142 may be formed by assembling multiple housings. In some examples, due to modeling or mold manufacturing reasons, the motor housing 142 has a split structure. Optionally, the motor housing 142 may have a structure formed by two parts. For example, the motor housing 142 includes a left half housing and a right half housing, a front half housing and a rear half housing, or an upper half housing and a lower half housing that can be spliced together. Optionally, the motor housing 142 may have a structure formed by multiple parts. For example, the motor housing 142 is made of plastic material. In this example, the output housing 141 may have an integral structure or a split structure. Optionally, the output housing 141 includes at least a front housing 141a disposed around the output shaft 121, and the front housing 141a supports at least a bearing or a sleeve on the outer side of the output shaft 121. In this example, the front housing 141a is made of metal material. To ensure the connection between the output housing 141 and the motor housing 142, the output housing 141 includes a left half housing and a right half housing, a front half housing and a rear half housing, or an upper half housing and a lower half housing that can be spliced together.

Since the impact wrench 100 is relatively heavy and difficult to operate with one hand, a second handle 16 is further disposed at an end of the housing 14 facing the output shaft 121. The first handle 15 and the second handle 16 may be held by two hands, respectively. The first handle 15 is held so that the switch of the impact tool 100 can be operated and the direction changing can be controlled, and the second handle 16 is held to assist in lifting and carrying, making it more convenient and labor-saving to use the impact wrench 100. In this example, the second handle 16 is connected to the output housing 141. In some examples, the second handle 16 is connected to the front housing 141a. The second handle 16 includes a handle 161 and a mounting portion 163. The mounting portion 163 connects the second handle 16 to the housing 14. The handle 161 may be substantially U-shaped or ring-shaped. In some examples, the handle 161 may be covered by an elastomeric overmolded part.

The second handle 16 may be pivotally connected to the housing 14 and may be adjusted between various orientations. In an example, the impact wrench 100 does not include the second handle. In some examples, the second handle 16 is relatively fixedly connected to the housing 14.

The impact wrench 100 further includes power supply mounting portions 19. The power supply mounting portion 19 is provided with a mounting groove 192 with a guide rail 191. An electrical connector is disposed in the mounting groove 192. The battery can slide into the mounting groove 192 and engage with the electrical connector. The battery pack 30 has a release button so that when the battery pack 30 is fully inserted into the guide rail 191 of a battery base, the release button unlocks a lock that locks the battery to the battery base. The battery pack 30 further has a battery level indicator 193 that is exposed at the top of the impact tool 100 and faces inward when the battery pack 30 is connected to the power supply mounting portion 19. In this example, the power supply mounting portions 19 are formed on or connected to the housing 14. For example, the power supply mounting portions 19 are disposed on the motor housing 142. Two power supply mounting portions 19 are symmetrically supported on two sides of the motor housing 142 with the first axis 101 as a central axis. The extension direction of the guide rail 191 defines the mounting direction of the battery pack 30 and the positioning direction after installation. Optionally, the guide rail of the first battery pack 30a extends along a first direction F1, and the guide rail of the second battery pack 30b extends along a second direction F2, where the first direction F1 is basically parallel to the second direction F2.

As shown in FIG. 3, a transmission mechanism 17 is disposed between the electric motor 11 and the impact assembly 13 and used for transmitting power between the motor shaft 111 and the main shaft. In this example, the transmission mechanism 17 is decelerated by a planet gear. The working principle according to which a planet gear performs the deceleration and the deceleration implemented by the transmission mechanism have been completely disclosed to those skilled in the art. Therefore, a detailed description is omitted herein for the brevity of the specification.

In this example, the impact wrench 100 is a power tool with high output torque. In this example, the output shaft 121 of the impact wrench 100 can output a torque of at least 1000 N·m. For example, the weight of the impact wrench 100 exceeds 5 kg. Optionally, the output shaft 121 of the impact wrench 100 can output a torque of at least 1500 N·m. Optionally, the output shaft 121 of the impact wrench 100 can output a torque of at least 2000 N·m. Optionally, the output shaft 121 of the impact wrench 100 can output a torque of at least 2500 N·m.

The preceding large impact tool 100 may be used in high torque applications. For example, the impact wrench 100 for heavy truck wheel fasteners is used for tightening and loosening the heavy truck wheel fasteners. The impact wrench 100 can apply a large tightening torque to the fastener. As defined herein, the term “tightening torque” refers to the torque applied to the fastener in a direction in which tension increases (that is, in a tightening direction). In particular, the impact assembly and transmission assembly of the impact wrench 100 convert the continuous torque input from the electric motor 11 to deliver a continuous rotational impact on a workpiece, thereby generating a tightening torque of at least 1500 N·m in the case where the electric motor 11 draws a current of no more than 100 A. In some examples, the impact assembly and the transmission assembly deliver the continuous rotational impact on the workpiece, thereby generating a tightening torque of at least 1500 Nom in the case where the electric motor 11 draws a current of no more than 80 A. In some examples, the impact assembly and transmission assembly of the impact wrench 100 convert the continuous torque input from the electric motor 11 to deliver the continuous rotational impact on the workpiece, thereby generating a tightening torque of at least 2000 N·m in the case where the electric motor 11 draws a current of no more than 100 A. In some examples, the impact assembly and the transmission assembly deliver the continuous rotational impact on the workpiece, thereby generating a tightening torque of at least 2000 N·m in the case where the electric motor 11 draws a current of no more than 80 A. The impact assembly and transmission assembly of the impact wrench 100 convert the continuous torque input from the electric motor 11 to deliver the continuous rotational impact on the workpiece, thereby generating a tightening torque of at least 2500 N·m in the case where the electric motor 11 draws a current of no more than 100 A. In some examples, the impact assembly and the transmission assembly deliver the continuous rotational impact on the workpiece, thereby generating a tightening torque of at least 2500 N·m in the case where the electric motor 11 draws a current of no more than 80 A.

In some examples, the weight of the impact wrench 100 exceeds 10 kg. In some examples, the weight of the impact wrench 100 exceeds 15 kg.

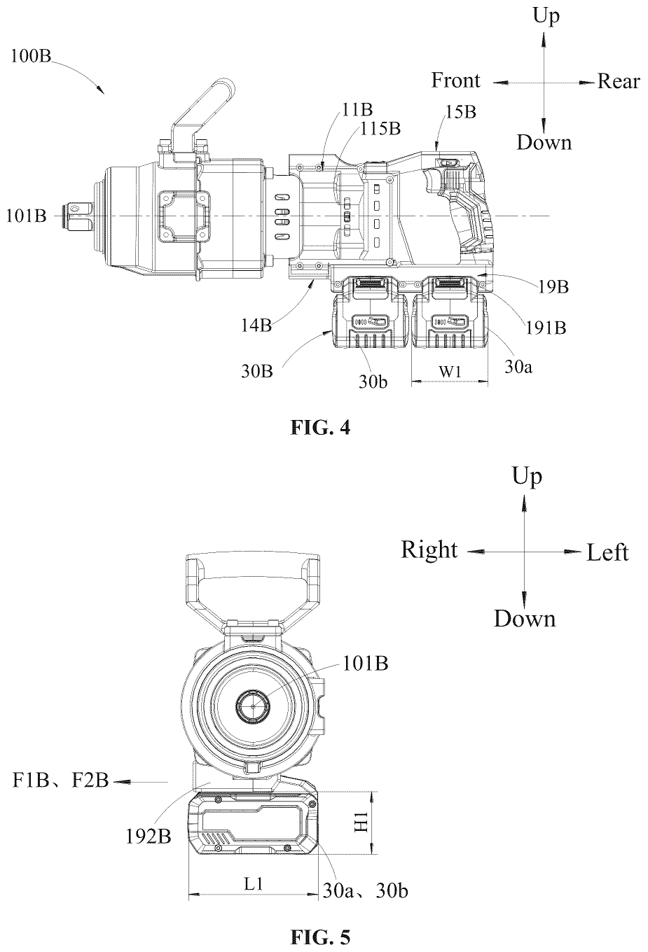

FIGS. 4 to 6 show an impact wrench 100B according to another example. The impact wrench 100B is similar to the impact wrench 100 described above with reference to FIGS. 1 to 3. Therefore, features and elements of the impact wrench 100B that correspond to features and elements of the impact wrench 100 are given similar reference numerals followed by the letter “B”. Furthermore, the following description focuses primarily on the differences between the impact wrench 100B and the impact wrench 100.

Along the direction of a first axis 101B, a DC power supply 30B′ at least partially overlaps an electric motor 11B, and the DC power supply 30B′ is supported on a housing 14B and disposed on the lower side of the housing 14B. For example, the first battery pack 30a and the second battery pack 30b are disposed on the lower side of the housing 14B separately. For example, the first battery pack 30a and the second battery pack 30b are disposed at the bottom of the housing 14B separately. In this example, at least one of the first battery pack 30a and the second battery pack 30b at least partially overlaps a stator 115B of the electric motor 11B. In this example, the first battery pack 30a and the second battery pack 30b each have a nominal capacity greater than or equal to 5 Ah, and the first battery pack 30a or the second battery pack 30b at least partially overlaps the stator 115B of the electric motor 11B.

Along the direction of the first axis 101B, the DC power supply 30B′ at least partially overlaps a first handle 15B. In this example, the first battery pack 30a or the second battery pack 30b is at least partially disposed at the bottom of the first handle 15B. Power supply mounting portions 19B are disposed on the housing of the electric motor 11B and the lower housing of the first handle 15B, respectively. The power supply mounting portion 19B is provided with a mounting groove 192B with a guide rail 191B, and the extension direction of the guide rail 191B defines the mounting direction of the battery pack 30 and the positioning direction after installation. Optionally, the guide rail of the first battery pack 30a extends along a first direction F1B, and the guide rail of the second battery pack 30b extends along a second direction F2B. For example, the first direction F1B is basically parallel to the second direction F2B. For example, the included angle between the first direction F1B and the second direction F2B is 0 degrees, that is to say, the first battery pack 30a and the second battery pack 30b are mounted on the power supply mounting portions 19B in the same direction. For example, the included angle between the first direction F1B and the second direction F2B is 180 degrees, that is to say, the first battery pack 30a and the second battery pack 30b are mounted on the power supply mounting portions 19B from opposite directions, respectively.

The battery pack 30 has a length direction L1, a width direction W1, and a height direction H1, and the dimension of the battery pack 30 in the length direction L1 is greater than the dimension of the battery pack 30 in the width direction W1 and greater than the dimension of the battery pack 30 in the height direction H1. The first battery pack 30a and the second battery pack 30b are coupled to the power supply mounting portions 19B along the length direction L1. For example, the length direction L1 of the first battery pack 30a and the second battery pack 30b is orthogonal to the direction of the first axis 101B. In this example, the first battery pack 30a and the second battery pack 30b are coupled to the power supply mounting portions 19B along the left and right direction. The first battery pack 30a and the second battery pack 30b are arranged in sequence along the width direction W1 of the battery pack 30.

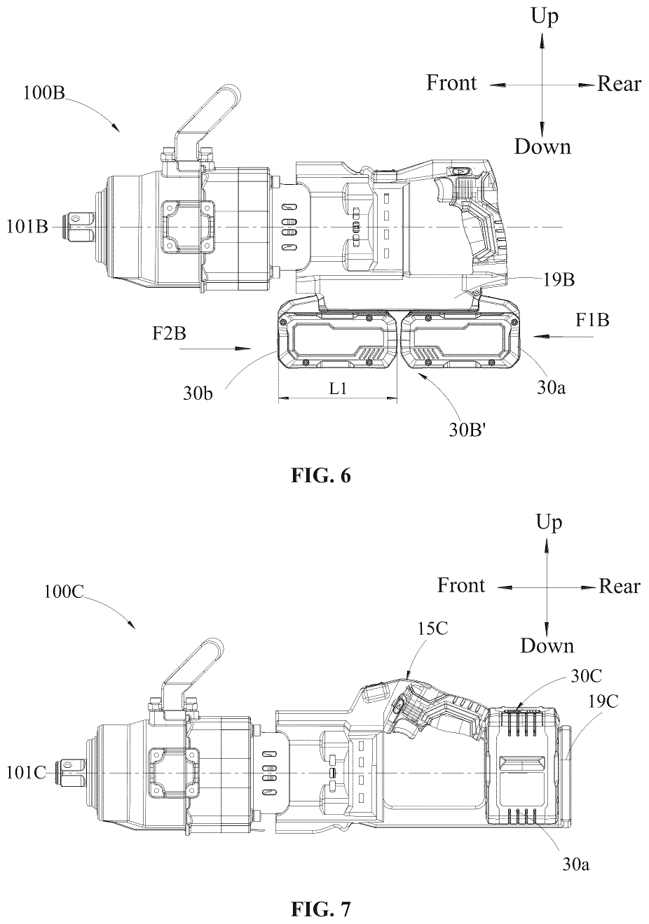

As shown in FIG. 6, the first battery pack 30a and the second battery pack 30b are coupled to the power supply mounting portions 19B along the length direction L1. For example, the length direction L1 of the first battery pack 30a and the second battery pack 30b is parallel to the direction of the first axis 101B. In this example, the first battery pack 30a and the second battery pack 30b are coupled to the power supply mounting portions 19B along the front and rear direction. The guide rail of the first battery pack 30a extends along the first direction F1B, and the guide rail of the second battery pack 30b extends along the second direction F2B, where the first direction F1B coincides with the second direction F2B, that is to say, the first battery pack 30a and the second battery pack 30b are coaxially mounted. The first battery pack 30a and the second battery pack 30b are arranged in sequence along the length direction L1 of the battery pack 30. In this example, the included angle between the insertion direction of the first battery pack and the insertion direction of the second battery pack is 180°.

FIG. 7 shows an impact wrench 100C according to another example. The impact wrench 100C is similar to the impact wrench 100 described above with reference to FIGS. 1 to 3. Therefore, features and elements of the impact wrench 100C that correspond to features and elements of the impact wrench 100 are given similar reference numerals followed by the letter “C”. Furthermore, the following description focuses primarily on the differences between the impact wrench 100C and the impact wrench 100.

Along the direction of a first axis 101C, a DC power supply 30C is disposed on the rear side of a first handle 15C. For example, along the direction of the first axis 101C, power supply mounting portions 19C are disposed on the rear side of the first handle 15C. In this example, the DC power supply 30C is supported by the first handle 15C and the battery packs are disposed on the left side and/or the right side of the first handle 15C. For example, the first battery pack 30a and the second battery pack 30b are disposed on the left side and the right side of the first handle 15C, respectively. The first battery pack 30a and the second battery pack 30b are disposed on the left side and the right side of the first handle 15C, respectively. It is to be understood that the first battery pack 30a is only located on the left side or right side of a housing 14C, the second battery pack is only located on the right side or left side of the housing 14C, and neither the first battery pack 30a nor the second battery pack straddles the left and right sides. Optionally, the first battery pack 30a and the second battery pack 30b are symmetrically supported on two sides of the first handle 15C with the first axis 101C as a central axis.

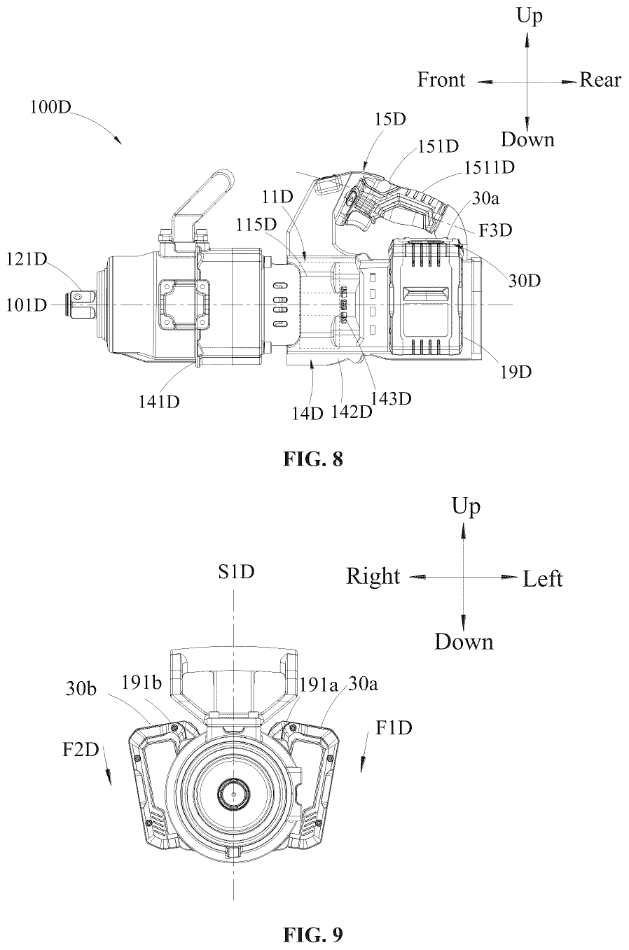

FIGS. 8 and 9 show an impact wrench 100D according to another example. The impact wrench 100D is similar to the impact wrench 100 described above with reference to FIGS. 1 to 3. Therefore, features and elements of the impact wrench 100D that correspond to features and elements of the impact wrench 100 are given similar reference numerals followed by the letter “D”. Furthermore, the following description focuses primarily on the differences between the impact wrench 100D and the impact wrench 100.

A first handle 15D is disposed at an end of a housing 14D facing away from an output shaft 121D. In this example, along the direction of a first axis 101D, the first handle 15D at least partially overlaps the housing of an DC power supply 30D so that the dimension of the whole formed by the first handle 15D and the DC power supply 30D along the direction of the first axis 101D is less than the sum of the dimension of the first handle 15D along the direction of first axis 101D and the dimension of the DC power supply 30D along the direction of the first axis 101D. For example, a grip 151D of the first handle 15D extends along a third direction F3D. For example, the grip 151D of the first handle 15D is inclined and extends upward from a motor housing 142D along the third direction F3D to above the electric motor 11D.

The DC power supply 30D is behind the electric motor 11D along the direction of the first axis 101D. For example, the first battery pack 30a and the second battery pack 30b are disposed behind a stator 115D separately. Along the direction of the first axis 101D, the first handle 15D at least partially overlaps the DC power supply 30D. For example, along the direction of the first axis 101D, a grip part 1511D at least partially overlaps the DC power supply 30D. In this manner, the axial dimension of the impact tool 100D can be reduced.

The DC power supply 30D is supported on the housing 14D and disposed on the left side and/or the right side of the housing 14D. For example, the first battery pack 30a and the second battery pack 30b are disposed on the left side and the right side of the housing 14D, respectively. In this example, a vertical plane passing through the first axis 101D is set as a central plane SID, and two sides of the central plane are defined as the left side and the right side of the housing 14D. The first battery pack 30a and the second battery pack 30b are disposed on the left side and the right side of the housing 14D, respectively. It is to be understood that the first battery pack 30a is only located on the left side or right side of the housing 14D, the second battery pack 30b is only located on the right side or left side of the housing 14D, and neither the first battery pack 30a nor the second battery pack 30b straddles the left and right sides. Optionally, the first battery pack 30a and the second battery pack 30b are symmetrically supported on two sides of the housing 14D with the first axis 101D as a central axis.

In this example, the DC power supply 30D is disposed on the rear side of an air inlet 143D. For example, the DC power supply 30D and the air inlet 143D are staggered so that the DC power supply 30D does not block the air inlet 143D at all.

In this example, power supply mounting portions 19D are formed on or connected to the housing 14D. For example, the power supply mounting portions 19D are disposed on the motor housing 142D. Two power supply mounting portions 19D are symmetrically supported on two sides of the motor housing 142D with the first axis 101D as a central axis. The extension direction of a guide rail 191D defines the mounting direction of the battery pack 30 and the positioning direction after installation. Optionally, the guide rail 191D of the first battery pack 30a extends along a first direction F1D, and the guide rail 191D of the second battery pack 30b extends along a second direction F2D, where the first direction F1D intersects with the second direction F2D, that is to say, the first direction FID and the second direction F2D are oriented in a V shape relative to each other, and the tops of the guide rails 191D are spaced farther apart from each other than the bottoms of the guide rails 191D. In this manner, the radial dimension of the impact tool 100D can be reduced. In this example, as shown in FIG. 9, the impact wrench 100D is orthogonally projected along the first axis 101D, and the electric motor 11D and the DC power supply 30 overlap radially. In the up and down direction, the lower part of the DC power supply 30 does not extend beyond the outline of an output housing 141D.

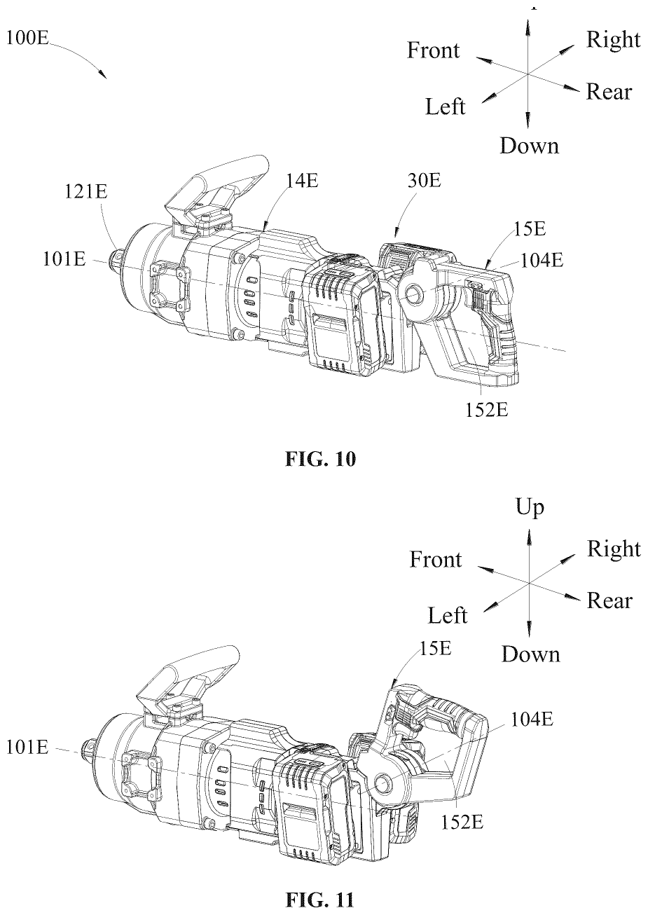

FIGS. 10 to 13 show an impact wrench 100E according to another example. The impact wrench 100E is similar to the impact wrench 100 described above with reference to FIGS. 1 to 3. Therefore, features and elements of the impact wrench 100E that correspond to features and elements of the impact wrench 100 are given similar reference numerals followed by the letter “E”. Furthermore, the following description focuses primarily on the differences between the impact wrench 100E and the impact wrench 100.

In this example, along the direction of a first axis 101E, a DC power supply 30E is disposed between a first handle 15E and an output shaft 121E; the first handle 15E is rotatably connected to a housing 14E about a handle axis 104E, the first handle 15E is provided with a first opening 152E for accommodating fingers, and the opening direction 1e of the first opening 152E is parallel to the direction of the handle axis 104E.

The first handle 15E has multiple adjustable working positions around the handle axis 104E, for example, a first working position shown in FIG. 10 and a second working position shown in FIG. 11. When the first handle 15E is at any working position, the first handle 15E can be maintained at the selected working position so that the user can hold the first handle 15E to operate the impact wrench 100E. In this example, the handle axis 104E is orthogonal to the first axis 101E. For example, the first handle 15E is provided with the first opening 152E along the left and right direction, and the handle axis 104E extends along the left and right direction. For example, the first handle 15E is provided with the first opening 152E along the up and down direction, and the handle axis 104E extends along the up and down direction.

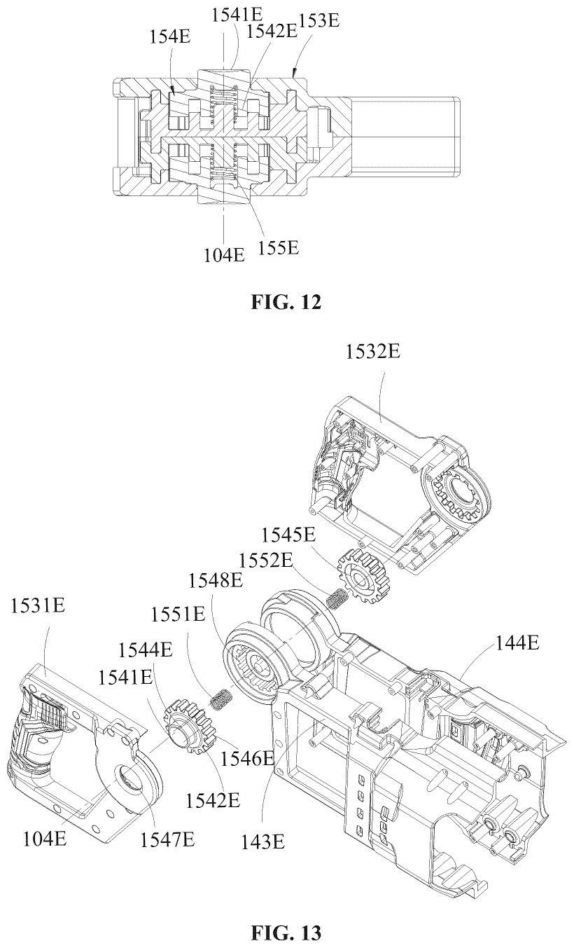

As shown in FIGS. 12 and 13, the first handle 15E includes a housing assembly 153E and an adjustment assembly 154E. The housing assembly 153E is in the form of a left half housing and a right half housing and includes a first housing 1531E and a second housing 1532E. The first housing 1531E and the second housing 1532E are spliced to form an accommodation space, and the adjustment assembly 154E is at least partially located in the accommodation space. The first handle 15E is rotatably connected to a motor housing 142E, and the motor housing 142E is in the form of a left half housing and a right half housing and includes a first motor housing 143E and a second motor housing 144E. The adjustment assembly 154E connects the first handle 15E to the motor housing 142E.

The adjustment assembly 154E includes an operating member 1541E, a limiting member 1542E, and a rotary shaft member 1543E. The operating member 1541E is at least partially disposed outside the first handle 15E and the motor housing 142E. The operating member 1541E is used to be triggered by the user to adjust the angle of the first handle 15E. The rotary shaft member 1543E connects the first handle 15E to the motor housing 142E. In this example, the rotary shaft member 1543E passes through the first housing 1531E, the first motor housing 143E, the second motor housing 144E, and the second housing 1532E in sequence. The handle axis 104E is the centerline of the rotary shaft member 1543E. In this example, the rotary shaft member 1543E is formed by two parts: a left part and a right part. The rotary shaft member 1543E includes a first rotary shaft 1544E and a second rotary shaft 1545E. The limiting member 1542E is used for maintaining the first handle 15E at the selected working position. The limiting member 1542E includes a tooth portion 1546E disposed circumferentially around the handle axis 104E and mating teeth meshing with the tooth portion 1546E of the limiting member 1542E. The limiting member 1542E meshes with the first handle 15E and the motor housing 142E at the same time. The inner sidewall of the first housing 1531E is provided with first mating teeth 1547E meshing with the tooth portion 1546E of the limiting member 1542E, and the first motor housing 143E is provided with second mating teeth 1548E meshing with the tooth portion 1546E of the limiting member 1542E.

The case where the user needs to adjust the first handle 15E from the first working position shown in FIG. 10 to the second working position shown in FIG. 11 is to be understood as the case where the user needs to adjust the position of the first handle 15E relative to the motor housing 142E, that is, the working position. The user triggers the operating member 1541E to disengage the tooth portion 1546E of the limiting member 1542E from the first mating teeth 1547E, and the tooth portion 1546E of the limiting member 1542E meshes only with the second mating teeth 1548E. The first handle 15E is rotated about the handle axis 104E to a required working position as needed, and then the limiting member 1542E is reset such that the tooth portion 1546E meshes with the first mating teeth 1547E and the second mating teeth 1548E. In this manner, the position of the first handle 15E relative to the motor housing 142E is maintained at the required working position. In this example, the limiting member 1542E is formed by two parts: a left part and a right part. Therefore, a first limiting member 1542E meshes with the first mating teeth 1547E and the second mating teeth 1548E, respectively, and a second limiting member 1542E meshes with third mating teeth on the second motor housing 144E and fourth mating teeth on the second housing 1532E, respectively.

In this example, the operating member 1541E and the limiting member 1542E are formed on or connected to the rotary shaft member 1543E. The limiting member 1542E is disposed along the circumferential direction of the rotary shaft member 1543E, and the operating member 1541E is disposed on the outer surface of the rotary shaft member 1543E. Optionally, the adjustment assembly 154E further includes a reset member 155E for driving the tooth portion 1546E of the limiting member 1542E to mesh with the first mating teeth 1547E and the fourth mating teeth. The reset member 155E includes a coil spring. The reset member 155E is disposed between the limiting member 1542E and the motor housing 142E. For example, a first reset member 1551E is disposed between the first limiting member 1542E and the first motor housing 143E, and a second reset member 1552E is disposed between the second limiting member 1542E and the second motor housing 144E. The first reset member 1551E always provides the first limiting member 1542E with a force for moving toward the first housing 1531E, and the second reset member 1552E always provides the second limiting member 1542E with a force for moving toward the second housing 1532E.

It is to be understood that in some examples, the operating member 1541E may not be provided, and the user can directly rotate the first handle 15E to disengage the tooth portion 1546E of the limiting member 1542E from the mating teeth; when the first handle 15E is rotated to a certain angle, the tooth portion 1546E of the limiting member 1542E meshes with the mating teeth again, thereby locking the position of the first handle 15E relative to the motor housing 142E.

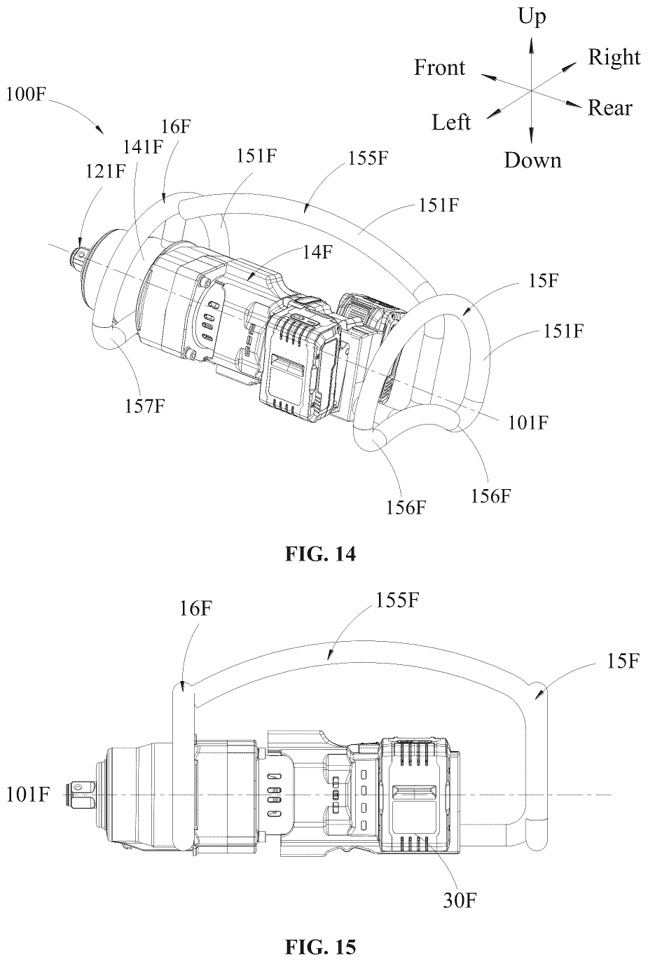

FIGS. 14 and 15 show an impact wrench 100F according to another example. The impact wrench 100F is similar to the impact wrench 100 described above with reference to FIGS. 1 to 3. Therefore, features and elements of the impact wrench 100F that correspond to features and elements of the impact wrench 100 are given similar reference numerals followed by the letter “F”. Furthermore, the following description focuses primarily on the differences between the impact wrench 100F and the impact wrench 100.

In this example, a first handle 15F is disposed at an end of a housing 14F facing away from an output shaft 121F along the direction of a first axis 101F, and the first handle 15F surrounds at least the left side, the upper part, and the right side of the outer periphery of the housing 14F. A second handle 16F is connected to an output housing 141F, and the second handle 16F surrounds at least the left side, the upper part, and the right side of the outer periphery of the housing 14F. A third handle 155F extends along the first axis 101F and connects the first handle 15F to the second handle 16F.

The first handle 15F and the second handle 16F each form an annular handle, and the bottoms of the first handle 15F and the second handle 16F form a first support 156F and a second support 157F, respectively. The first support 156F and the second support 157F extend out of the bottom surface of the housing 14F or are flush with the bottom surface of the housing 14F. When the impact wrench 100 is placed on the ground, the first support 156F and the second support 157F together form a bracket that can support the impact wrench 100.

The first handle 15F and the second handle 16F are arranged along the front and rear direction and surround the left side, the upper part, and the right side of the outer periphery of the housing 14F. The first handle 15F and the second handle 16F are orthogonally projected along the first axis 101F, and the first handle 15F basically completely coincides with the second handle 16F. The first handle 15F and the second handle 16F serve as the supports so that the impact wrench 100F can be placed sideways when placed on the ground. Even when the impact wrench 100F falls, the impact wrench 100F and the DC power supply 30 can be protected.

The first handle 15F, the second handle 16F, and the third handle 155F provide the user with more comfortable alternative holding positions, and the first handle 15F, the second handle 16F, and the third handle 155F are each provided with a curved grip 151F.

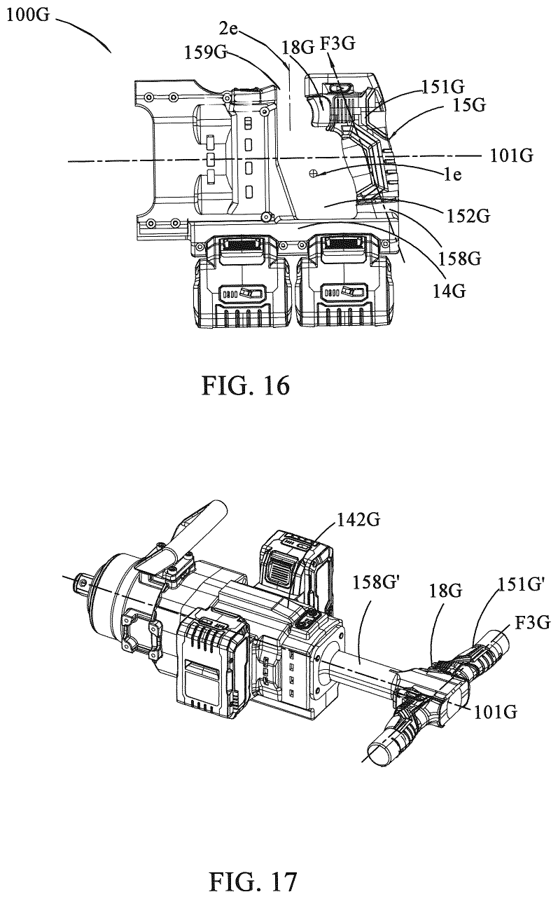

FIGS. 16 to 18 show an impact wrench 100G according to another example. The impact wrench 100G is similar to the impact wrench 100 described above with reference to FIGS. 1 to 3. Therefore, features and elements of the impact wrench 100G that correspond to features and elements of the impact wrench 100 are given similar reference numerals followed by the letter “G”. Furthermore, the following description focuses primarily on the differences between the impact wrench 100G and the impact wrench 100.

In this example, a first handle 15G includes a connection portion 158G and a grip 151G extending along a third direction F3G, where an end of the grip 151G is connected to a housing 14G through the connection portion 158G, and the other end of the grip 151G is a free end.

The first handle 15G is provided with a power switch 18G for turning on and off the motor, where the switch is disposed on the grip 151G.

In some examples, as shown in FIG. 16, the third direction F3G intersects with the direction of a first axis 101G. The first handle 15G includes a first opening 152G for accommodating fingers and a second opening 159G whose opening direction 2e intersects with the opening direction 1e of the first opening 152G. In some examples, the opening direction 2e of the second opening 159G is perpendicular to the opening direction of the first opening. So, the second opening 159G disconnects the upper end of the first handle 15G from the motor housing.

In some examples, as shown in FIG. 17, a connection portion 158G′ is connected to a motor housing 142G, and the connection portion 158G′ extends toward the rear part of the motor housing 142G along the first axis 101G. Grips 151G′ extend along the third direction F3G to two sides of the connection portion 158G′, and the third direction F3G intersects with the direction of the first axis 101G. For example, the third direction F3G is orthogonal to the first axis 101G. The grips 151G′ extend on the left and right sides of the connection portion 158G′. The power switch 18G is disposed on the grip 151G′ on the left side or the right side. For example, the first handle 15G is T-shaped and has laterally extending grips 151G′ for easy holding with two hands. The laterally extending grips 151G′ are disassembled to form a straight handle, or one of the laterally extending grips 151G′ is disassembled to form an L-shaped handle, or the first handle 15G is rotated by 90° to make the laterally extending grip 151G′ face downward or upward so that the impact tool 100G becomes smaller in size.

The first handle 15G further includes a telescopic mechanism, or the first handle 15G includes a foldable mechanism.

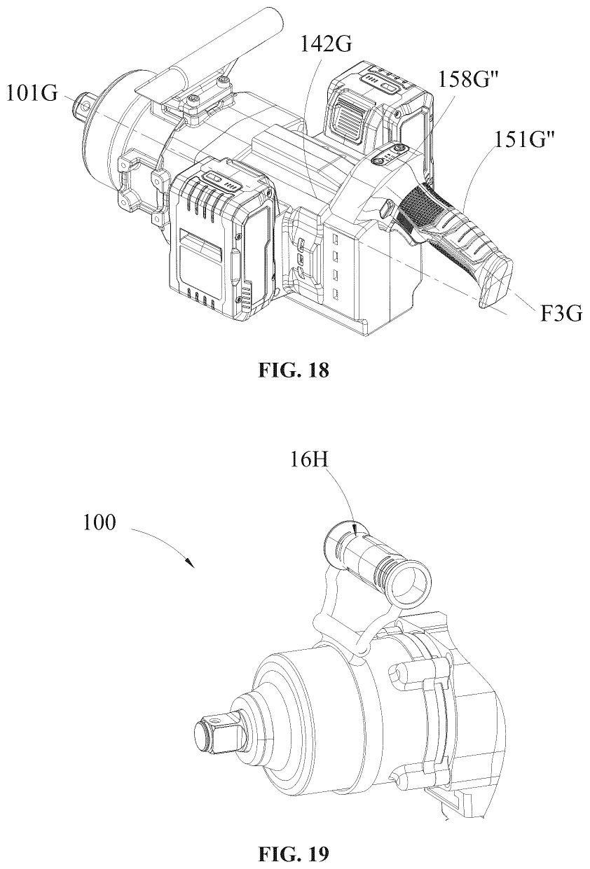

In some examples, as shown in FIG. 18, a connection portion 158G″ is connected to the motor housing 142G, and the connection portion 158G″ is disposed on the upper part of the motor housing 142G. A grip 151G″ extends downward along the third direction F3G, where the third direction F3G intersects with the direction of the first axis 101G.

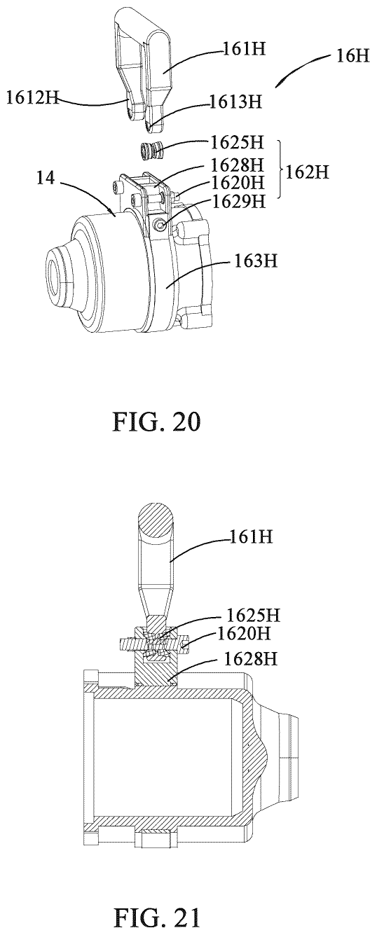

FIGS. 20 and 21 show a configuration of a second handle 16H of the impact wrench 100. The impact wrench 100 may be any one of 100, 100B, 100C, 100D, 100E, 100F, and 100G. This example mainly focuses on the structure of the second handle 16H.

The second handle 16H further includes a connection assembly 162H for connecting a handle 161H to a mounting portion 163H. The connection assembly 162H includes a connection base 1628H, first fasteners 1629H, and second fasteners 1620H, where the first fasteners 1629H apply forces to the mounting portion 163H to cause the mounting portion 163H to radially contract so that the friction between the mounting portion 163H and the housing 14 is increased, and the mounting portion 163H presses the housing 14. The mounting portion 163H is formed on or connected to the connection base 1628H, and the first fasteners 1629H are mounted on the connection base 1628H. The second fasteners 1620H position and connect the handle 161H to the connection base 1628H. Shock absorber pads 1625H are disposed between the connection base 1628H and the second fastener 1620H. The shock absorber pads 1625H are disposed between the handle 161H and the connection base 1628H. The handle 161H is basically U-shaped or semi-ring-shaped. The handle 161H includes a continuously grip rod 1611H and free ends 1612H for connection. The free ends 1612H of the handle 161H extend into a mounting groove 1635H of the connection base 1628H, and the shock absorber pads 1625H are disposed between the mounting groove 1635H and the free ends 1612H of the handle 161H. In this example, the shock absorber pads 1625H are disposed on the front side and rear side of the handle 161H, respectively, thereby improving the shock absorbing effect. When the impact assembly applies the impact force to the output shaft, the collision between the impact block and the hammer anvil generates a relatively large vibration of the impact wrench. The second handle 16H is mounted on the output housing 141. To ensure the shock absorbing effect, on the one hand, the handle 161H and the connection base 1628H are designed as separate parts to cut off the vibration transmission path, thereby absorbing shock; on the other hand, the shock absorber pads are provided between the handle 161H and the connection base 1628H, thereby damping vibrations.

In this example, the first fasteners 1629H apply forces to the mounting portion 163H in the left and right direction to radially tighten the mounting portion 163H. For example, the first fasteners 1629H are bolts, the first fasteners 1629H are mounted at the left and right ends of the mounting portion 163H, respectively, and the mounting portion 163H is radially tightened by the threaded structures so that the mounting portion 163H is contracted and then presses the output housing 141. The second fastener 1620H passes through the connection base 1628H and the free end 1612H of the handle 161H along the direction of a first axis 101H. For example, the second fasteners 1620H are bolts, the second fasteners 1620H are mounted at the two free ends 1612H of the handle 161H, respectively, and the connection base 1628H and the handle 161H are locked by the threaded structures.

In some examples, the first fastener 1629H and the second fastener are combined into the first fastener 1629H. In this example, the free ends 1612H of the handle 161H are each formed with or connected to a fixing member 1613H so that the free ends 1612H of the handle 161H are connected to the connection base 1628H. The first fasteners 1629H pass through the mounting portion 163H, the connection base 1628H, and the fixing members 1613H, thereby connecting the second handle 16H to the housing 14. The shock absorber pads 1625H are disposed between the fixing members 1613H of the handle 161H and the connection base 1628H. Optionally, the first fasteners 1629H extend along the left and right direction, and the shock absorber pads 1625H are disposed on the left and right sides of the fixing members 1613H of the handle 161H, respectively. The first fasteners 1629H are bolts, and the mounting portion 163H is radially tightened by the threaded structures so that the mounting portion 163H is contracted and then presses the output housing 141. At the same time, the connection base 1628H and the handle 161H are locked by the threaded structures. For example, a matching stop portion is disposed between the connection base 1628H and the fixing member 1613H, the installation positions of the connection base 1628H and the fixing member 1613H are positioned by the stop portion, and the positions of the connection base 1628H and the handle 161H are locked by the first fasteners 1629H.

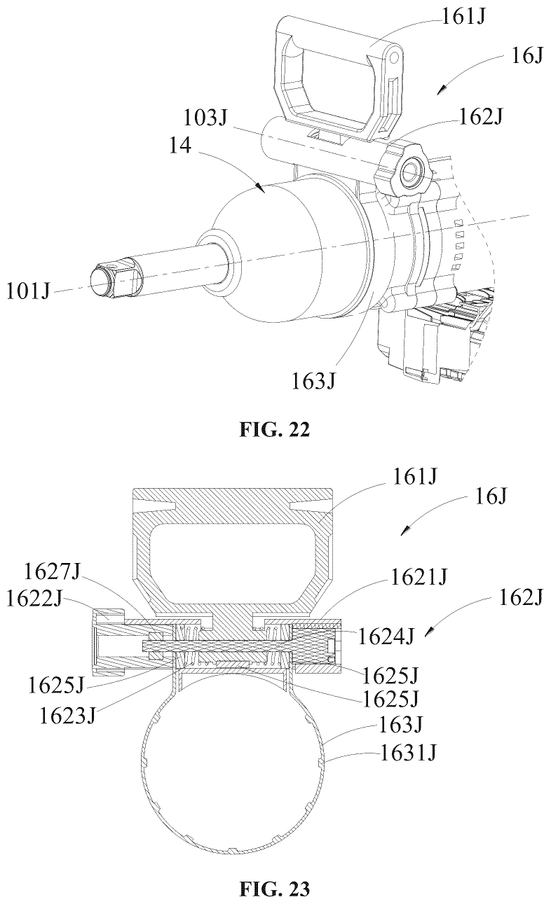

FIGS. 22 and 23 show a second handle 16J according to another example. The second handle 16J is similar to the second handle 16H described above with reference to FIG. 20. Therefore, features and elements of the second handle 16J that correspond to features and elements of the second handle 16H are given similar reference numerals followed by the letter “J”. Furthermore, the following description focuses primarily on the differences between the second handle 16J and the second handle 16H.

The second handle 16J includes a handle 161J, a connection assembly 162J, and a mounting portion 163J. The connection assembly 162J includes a support tube 1621J, an operating member 1622J, and a third fastener 164J. The support tube 1621J serves as a body housing, an accommodation space is provided inside the support tube 1621J, the operating member 1622J is at least partially disposed on the outer side of the support tube 1621J, and the third fastener 164J is at least partially disposed in the accommodation space. The handle 161J and the mounting portion 163J are connected to the support tube 1621J separately. The third fastener 164J fixes the mounting portion 163J to the housing 14 and fixes the handle 161J to the mounting portion 163J separately. The third fastener 164J includes shock absorber pads 1625J, and the shock absorber pads 1625J are disposed between the support tube 1621J and the handle 161J.

For example, the third fastener 164J includes a latch 1624J, a nut 1627J, and springs 1623J. The operating member 1622J is connected to an end of the support tube 1621J, the nut 1627J is connected to the inside of the operating member 1622J, an end of the latch 1624J is connected to the inside of the support tube 1621J and passes through the support tube 1621J, and the other end of the latch 1624J is connected to the nut 1627J. The handle 161J is disposed within the support tube 1621J. The support tube 1621J is provided with two grooves, and two ends of the mounting portion 163J pass through the two grooves, respectively and are both penetrated by the latch 1624J. The two ends of the mounting portion 163J are disposed on two sides of the handle 161J, respectively. The springs 1623J are disposed on the left and right sides of the handle 161J, respectively. An end of each of the two springs abuts against the handle 161J, and the other end of each of the two springs abuts against the mounting portion 163J. The shock absorber pad 1625J is disposed between the spring 1623J and the mounting portion 163J. Optionally, an end of the spring 1623J abuts against the handle 161J, and the other end of the spring 1623J abuts against the shock absorber pad 1625J. In this example, the shock absorber pads 1625J are arranged around three sides of the handle 161J, thereby achieving a better shock absorbing effect. The springs are compressed to generate pressure to fix the handle 161J.

The method for tightening the mounting portion 163J is as follows: during the rotation of the operating member 1622J, the threaded latch 1624J is threadedly connected to the nut 1627J on the operating member 1622J, the operating member 1622J presses the mounting portion 163J inward to compress the springs 1623J, and the mounting portion 163J is subjected to the elastic force of the springs 1623J and the pressure generated by the thread rotation to achieve contraction and tightening. The shock absorber pads 1625J and the springs 1623J work together to damp the vibrations of the handle 161J.

Limiting protrusions 1631J are provided on one of the outer side of the housing 14 and the inner side of the mounting portion 163J, and limiting grooves are provided on the other one of the outer side of the housing 14 and the inner side of the mounting portion 163J. The limiting protrusion 1631J is disposed in the limiting groove so that the mounting portion 163J and the housing 14 are prevented from rotating circumferentially.

In some examples, the handle 161J is rotatably connected to the housing 14 about a fourth axis 103J, and the mounting portion 163J and the housing 14 are positioned and connected. Optionally, the fourth axis 103J intersects with a first axis 101J. Optionally, the fourth axis 103J is perpendicular to the first axis 101J.

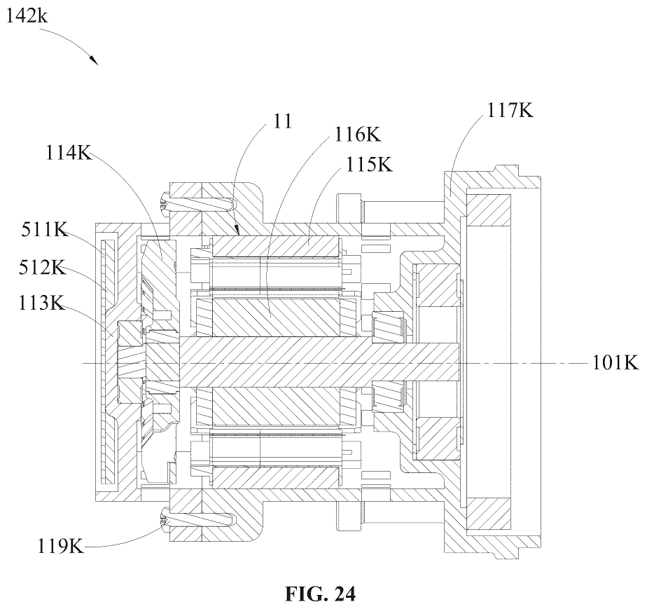

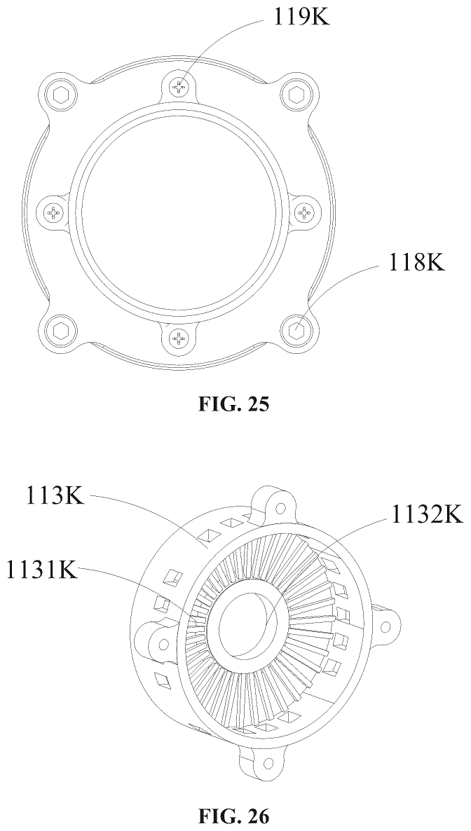

FIGS. 24 to 26 show a configuration of a motor housing 142K of the impact wrench 100. The impact wrench 100 may be any one of 100, 100B, 100C, 100D, 100E, 100F, and 100G. This example mainly focuses on the structure of the motor housing 142K.

The motor housing 142K includes a front cover housing 117K and a rear cover housing 113K. The length direction of the front cover housing 117K extends basically along a first axis 101K of the motor 11. The front cover housing 117K accommodates at least part of the motor 11. The rear cover housing 113K is mounted to the rear end of the front cover housing 117K. The rear cover housing 113K extends along the radial direction of the axis of the motor 11 to cover the opening at the rear end of the front cover housing 117K. The rear cover housing 113K includes an inner side and an outer side. It is to be understood that the inner side of the rear cover housing 113K is the side opposite to the opening of the front cover housing 117K. A first bearing seat 1132K is formed on or connected to the inner side of the rear cover housing 113K. The first bearing seat 1132K is used for supporting a first bearing at the rear end of the motor 11. Since the rear cover housing 113K is mounted to the rear end of the front cover housing 117K, the first bearing is the rear bearing of the motor 11 and is used for supporting the rotary motion of the rear end of the motor 11. A circuit board 511K is fixed on an aluminum substrate 512K, and the circuit board 511K and the aluminum substrate 512K are connected together to the outer side of the rear cover housing 113K. In this example, further, a second cover (not shown) is connected to the rear end of the rear cover housing 113K and is used for covering the opening on the outer side of the rear cover housing 113K so that the rear cover housing 113K forms a complete appearance.

The motor 11 includes a fan 114K, a stator 115K, and a rotor assembly 116K. During assembly, the stator 115K is assembled in the front cover housing 117K and axially connected to the front cover housing 117K via third fasteners 118K. The inner wall of the front cover housing 117K forms a first support portion to provide circumferential support for the stator 115K. The rotor assembly 116K passes through the stator 115K, and a rotor shaft of the rotor assembly 116K is connected to the rear cover housing 113K through the first bearing. The rear cover housing 113K and the front cover housing 117K are connected via fourth fasteners 119K, and the third fasteners 118K and the fourth fasteners 119K are staggered in the circumferential direction. The front cover housing 117K and the rear cover housing 113K are connected by bolts.

The fan 114K is connected to the inner side of the rear cover housing 113K and the front side of the first bearing. The circuit board 511K and the aluminum substrate 512K are connected together to the outer side of the rear cover housing 113K. Heat dissipation bosses or fins 1131K are provided inside the rear cover housing 113K. When the fan 114K dissipates heat for the thermally conductive rear cover housing 113K, the fan 114K indirectly dissipates heat for the circuit board 511K.

A gearbox is usually provided between the motor 11 and the impact assembly 13. A second support portion is disposed on a side of the front cover housing 117K facing away from the rear cover housing 113K. The front cover housing 117K and the second support position are connected by bolts or integrally formed. The second support position is used for connecting the inner ring gear in the gearbox.

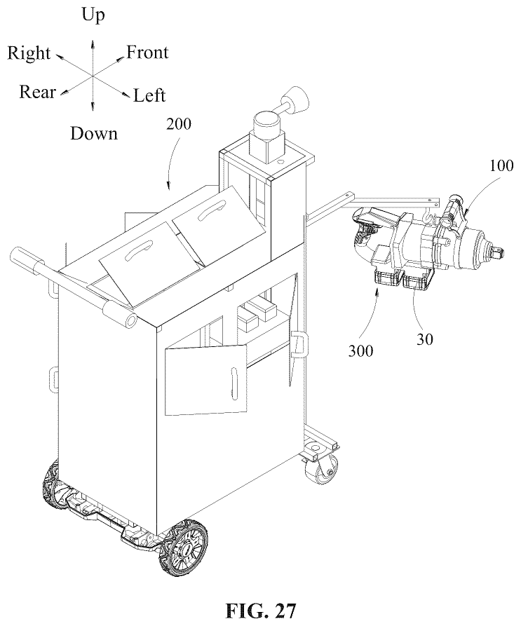

FIG. 27 shows a power tool combination and an auxiliary device. The impact wrench may be any one of 100, 100B, 100C, 100D, 100E, 100F, and 100G. This example mainly focuses on the structures of the power tool combination and the auxiliary device.

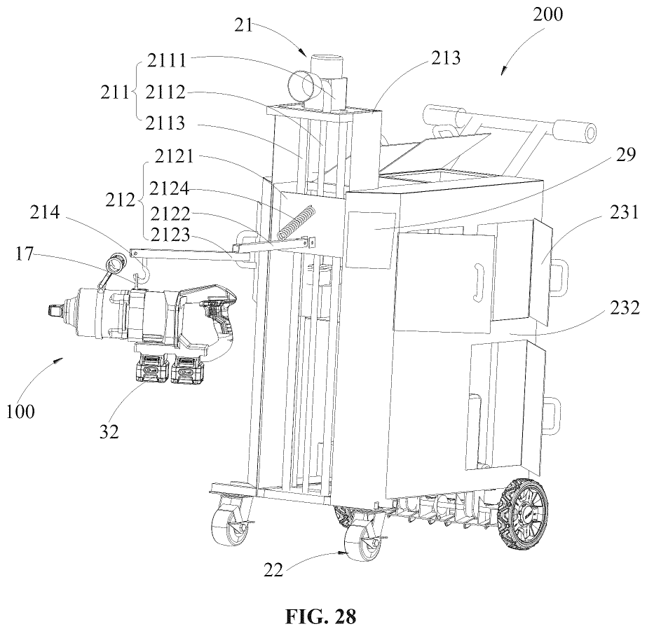

This example provides a power tool combination. As shown in FIGS. 27 to 30, the power tool such as the impact wrench 100, 100B, 100C, 100D, 100E, 100F, or 100G, an auxiliary device 200, and a power supply 300 are included. For the convenience of reference below, the power tool is, for example, the impact wrench 100.

The power supply 300 supplies power to at least one of the impact wrench 100 and the auxiliary device 200. In this example, the power supply 300 is a DC power supply. Optionally, the DC power supply is the battery pack 30, and the electrical components in the power tool combination are powered by the battery pack 30 in conjunction with a corresponding power supply circuit. It is to be understood by those skilled in the art that the power supply is not limited to the scenario where the battery pack 30 is used, and the power may be supplied to the circuit elements through mains power, an alternating current power supply, or a combination of mains power and the battery pack 30 in conjunction with the corresponding rectifier circuit, filter circuit, and voltage regulator circuit.

In this example, the impact wrench 100 is a handheld power tool. Optionally, the handheld power tool has high output torque. Optionally, an output shaft 121J of the impact wrench 100 with high output torque can output a torque of at least 1500 N·m to complete a preset task of the impact wrench 100, for example, disassembling and assembling fasteners. The structure of the impact wrench 100 has been disclosed above, and the details are not repeated here.

As shown in FIGS. 27 to 29, the auxiliary device 200 includes a mechanical arm 21 and a traveling mechanism 22. The mechanical arm 21 is connected to the impact wrench 100. The mechanical arm 21 is configured to adjust the impact wrench 100 to a preset position. The mechanical arm 21 is supported by the traveling mechanism 22.

Since the power tool with high output torque is very heavy, especially for the handheld power tool, such as the impact wrench 100, the impact wrench 100 needs to be moved near the workpiece to complete the work, and the power tool is time-consuming and laborious to carry. The impact wrench 100 is coupled to the auxiliary device 200, and the traveling mechanism 22 can move the impact wrench 100 roughly to a target position without manual handling and lifting, thereby achieving rapid movement of the impact wrench 100. The mechanical arm 21 can adjust the impact wrench 100 to the preset position so that the impact wrench 100 is aligned with the workpiece and then disassembles and assembles the fastener on the workpiece. Through the traveling mechanism 22 and the mechanical arm 21, the impact wrench 100 is supported and adjusted for alignment, thereby reducing the difficulty of operation, alleviating the workload of the staff, and improving the working efficiency.

Therefore, in some examples, the power tool may be another handheld power tool weighing more than 5 kg For example, the power tool may be a blower, a blowing and suction machine, an air cannon, an angle drill, a work light, or the like.

The mechanical arm 21 includes a first movement assembly 211 and a second movement assembly 212 connected to each other. One of the first movement assembly 211 and the second movement assembly 212 is supported by the traveling mechanism 22, and an output end of the other one of the first movement assembly 211 and the second movement assembly 212 is connected to the impact wrench 100. In this example, the first movement assembly 211 drives the impact wrench 100 to move, and the second movement assembly 212 drives at least the impact wrench 100 to rotate. The mechanical arm 21 has multiple DOF, thereby improving the flexibility of the impact wrench 100 connected to the execution end of the mechanical arm 21, which is convenient for the operator to align the impact wrench 100 with the fastener. In an example, the first movement assembly 211 is supported by the traveling mechanism 22, the second movement assembly 212 is connected to the output end of the first movement assembly 211, the impact wrench 100 is connected to the output end of the second movement assembly 212, the first movement assembly 211 drives the second movement assembly 212 and the impact wrench 100 to move, and the second movement assembly 212 drives the impact wrench 100 to rotate. In another example, the second movement assembly 212 is supported by the traveling mechanism 22, the first movement assembly 211 is connected to the output end of the second movement assembly 212, the impact wrench 100 is connected to the output end of the first movement assembly 211, the second movement assembly 212 drives the first movement assembly 211 and the impact wrench 100 to rotate, and the first movement assembly 211 drives the impact wrench 100 to move.

In an example, the first movement assembly 211 drives the impact wrench 100 to move up and down, and the second movement assembly 212 has multiple joint structures to drive the impact wrench 100 to rotate about multiple different centerlines. In an example, the second movement assembly 212 provides at least two DOF of rotary motion, for example, left and right rotation about a vertical centerline and up and down rotation about a horizontal centerline, or left and right rotation about two vertical centerlines and up and down rotation about a horizontal centerline.

The mechanical arm 21 further includes a support frame 213 supported by and connected to the traveling mechanism 22, the first movement assembly 211 and the second movement assembly 212 are connected to the support frame 213, and the first movement assembly 211, the second movement assembly 212, and the support frame 213 include at least one drive motor 2111 for driving the first movement assembly 211 and the second movement assembly 212. The drive motor 2111 is provided to achieve automatic driving, thereby reducing the workload of the staff.

In an example, the first movement assembly 211 includes the drive motor 2111, a lead screw 2112, and a lead screw nut mating with the lead screw 2112. The drive motor 2111 and the lead screw 2112 are disposed on the support frame 213. The lead screw 2112 is provided along the vertical direction. The drive motor 2111 is drivingly connected to the lead screw 2112. The impact wrench 100 is connected to the lead screw 2112 and the nut directly or indirectly via the second movement assembly 212 so that the impact wrench 100 can move up and down. In another example, the first movement assembly 211 may be a linear drive structure such as a hydraulic cylinder, a pneumatic cylinder, or a linear electric motor 11J to move the impact wrench 100 up and down.

In an example, the second movement assembly 212 includes a support seat 2121, an elastic member 2124, a first hinge rod 2122 hinged with the support seat 2121, and a second hinge rod 2123 hinged with the first hinge rod 2122. The support seat 2121 is connected to the output end of the first movement assembly 211. The elastic member 2124 connects the first hinge rod 2122 to the support seat 2121. The first hinge rod 2122 rotates about the horizontal centerline, the second hinge rod 2123 rotates about the vertical centerline, the impact wrench 100 is connected to the second hinge rod 2123, and the first hinge rod 2122 and the second hinge rod 2123 can be manually pushed, thereby manual pushing the impact wrench 100 to rotate. The second hinge rod 2123 is provided with a hook 214, the impact wrench 100 is provided with a hanging ring 17, and the hanging ring 17 is hung on the hook 214, thereby facilitating the disassembly and assembly of the impact wrench 100 on the auxiliary device 200. In other examples, the second movement assembly 212 may be a multi-link mechanism, the impact wrench 100 is connected to an output end of the multi-link mechanism, and the drive structure drives the multi-link mechanism to move. In some examples, the second hinge rod 2123 is provided with a manipulator to actively grasp the hanging ring of the impact wrench 100.

The mechanical arm 21 may be a multi-DOF mechanical arm such as a six-DOF mechanical arm or a four-DOF mechanical arm in the existing art, the mechanical arm 21 is mounted on the traveling mechanism 22 directly or through the support frame 213, and the alignment of the impact wrench 100 is driven entirely by the drive motor 2111.

The traveling mechanism 22 includes a traveling wheel set 221, a base 222, and a traveling electric motor 223. The traveling wheel set 221 is rotatably connected to the base 222, the mechanical arm 21 is supported by the base 222, and the traveling electric motor 223 drives the traveling wheel set 221 to rotate, thereby achieving automatic traveling of the traveling mechanism 22. The traveling mechanism 22 further includes a transmission mechanism, and the traveling electric motor 223 is connected to the traveling wheel set 221 through the transmission mechanism, where the traveling wheel set 221 includes multiple traveling wheels, the traveling wheels are rotatably connected to the base 222 through axles, and through the transmission mechanism, the traveling electric motor 223 drives the axle to rotate. The transmission mechanism is, for example, a gear transmission mechanism. When the distance between the axle and the motor shaft 111 is relatively large, a belt transmission mechanism or a chain transmission mechanism may be used for the transmission connection. In other examples, a handrail may be provided on the auxiliary device 200, thereby holding the handrail to manually push the auxiliary device 200 to travel.

The traveling wheel set 221 includes front wheels 2211 and rear wheels 2212. The traveling electric motor 223 drives the rear wheels 2212. The front wheels 2211 are turning wheels with a turning function and may be manually controlled, remotely controlled, automatically controlled according to a preset traveling route, or tracked. For example, for some relatively regular disassembly and assembly working conditions, a path may be preset to achieve self-traveling and self-positioning. Reference is made to the existing art, and the details are not repeated here. The front wheels 2211 are omni wheels each with a self-locking function. The traveling mechanism 22 further includes a speed regulation assembly 224 added at the handrail. The speed regulation assembly 224 is configured to adjust the traveling speed of the traveling wheel set 221. For the speed regulation assembly 224, reference is made to the existing art, and the details are not repeated here.

The power tool combination further includes a control assembly, and the impact wrench 100 and the auxiliary device 200 are communicatively connected to the control assembly separately to achieve automatic control of the impact wrench 100 and the auxiliary device 200, for example, controlling the start, stop, rotational speed, and direction of rotation of the motor 11, controlling the mechanical arm 21 to drive the power tool to the preset position, and controlling the traveling speed and steering of the traveling mechanism 22. The control assembly includes a controller, and the controller uses a dedicated control chip, for example, a single-chip microcomputer or a microcontroller unit (MCU).

The power tool combination further includes a human-machine interaction panel 29 communicatively connected to the control assembly. The human-machine interaction panel 29 can display the current operating parameter of the power tool combination, for example, the parameter of the motor 11, the parameter of the traveling mechanism 22, or the parameter of the mechanical arm 21, thereby facilitating viewing and understanding of the current usage. Numerical control programming may be performed through the human-machine interaction panel 29, for example, setting the traveling route of the traveling mechanism 22, and setting the parameter of the speed regulation assembly 224 to adjust the traveling speed and other traveling parameters of the traveling wheel set 221, and setting the air pressure of the traveling wheel.

The auxiliary device 200 further includes a frame body assembly 23 disposed on the rear side of the mechanical arm 21. The frame body assembly 23 forms a storage space capable of storing the attachment of the power tool or the power tool. For example, the impact wrench 100 can be stored in the storage space, taken out of the storage space when the impact wrench 100 is to be used, and stored when the impact wrench 100 is not in use.

The auxiliary device 200 further includes a storage box 24 disposed in the storage space, where the storage box 24 can store small tools such as sleeves or gloves for easy access, and the small tools are separated from a first power supply 31 and the impact wrench 100 by the storage box 24 to avoid confusion and facilitate management.

In this example, the power supply 300 includes the first power supply 31 and a second power supply 32. The first power supply 31 is configured to supply power to the mechanical arm 21 and/or the traveling mechanism 22, and the second power supply 32 is configured to supply power to the impact wrench 100. In some examples, the power supply 300 may be a signal power supply disposed on the auxiliary device 200 or the impact wrench 100 and configured to supply power to the auxiliary device 200 and the impact wrench 100 simultaneously. The first power supply 31 is disposed in the storage space. The first power supply 31 includes at least one battery pack 30. The storage space is further equipped with a charger 26. The charger 26 is configured to charge the at least one battery pack 30. The second power supply 32 is the DC power supply 30 disposed on the impact wrench 100. The second power supply 32 includes at least one battery pack 30. The charger 26 can also charge the at least one battery pack 30 of the second power supply 32. The charger 26 is provided with two dual port charging interfaces so that the charger 26 can charge four 5.0 Ah battery packs 30 at one time, thereby improving the charging efficiency. Further, the human-machine interaction panel 29 can display the remaining power of the battery pack 30.

The auxiliary device 200 further includes a light 27 for achieving illumination. The light 27 may be disposed at the top of the mechanical arm 21 and has a large illumination range, or the light 27 may be disposed at the top of the frame body assembly 23, on the front side of the mechanical arm 21, or at other positions. The light 27 is provided with a rotatable or liftable seat to adjust the illumination range of the light 27. The brightness of the light 27 is adjustable. The light 27 is powered by the power supply 300.

The auxiliary device 200 further includes an air pump 28 for inflation, for example, inflating the traveling wheel set 221 of the traveling mechanism 22 or inflating the wheel sets of some vehicle tools. After the traveling wheels of the traveling wheel set 221 are replaced or used for a long time, the air pump 28 is used for inflating the traveling wheels. The air pump 28 is equipped with an air pressure display to prevent overinflation or underinflation.

The storage space is divided into multiple layers, thereby facilitating the storage and management of items. For example, the storage space is divided into three layers, and the storage box 24 is mounted on the first layer. Correspondingly, a door 231 for easy access to the items is provided at the top of the frame body assembly 23. The charger 26 is placed on the second-layer partition, and the impact wrench 100 can also be placed on the second-layer partition. The first power supply 31 and the air pump 28 are disposed on the third-layer partition. The door 231 for easy access to the impact wrench 100, the charger 26, and the air pump 28 is disposed on the side surface of the frame body assembly 23. Each layer is provided with multiple vertical boards to form compartments, thereby separating different structures and avoiding interference.

The outer surface covers of components such as the mechanical arm 21 and the frame body assembly 23 of the auxiliary device 200 are all spray-painted to prevent rust, thereby improving the aesthetics and corrosion resistance. For example, a protective cover 232 is provided to cover the outer side of the frame body assembly 23, and the surface of the protective cover 232 is spray-painted.

In an example, the dimensions of the auxiliary device 200 are that the length dimension is greater than or equal to 700 mm, the width dimension is greater than or equal to 1500 mm (the dimensions of the auxiliary device are measured without the power tool installed), and the height dimension is greater than or equal to 900 mm. For example, the dimensions of the auxiliary device 200 are 805 mm×1716 mm×1270 mm, the height of the handrail from the ground is greater than or equal to 850 mm, the up and down height range of the impact wrench 100 driven by the first movement assembly 211 is 180 mm to 1000 mm, the width of the handrail is 500 mm, the up and down stroke of the impact wrench 100 is 0 to 810 mm, and the pressure range of the air pump 28 is 0 to 12 jars. In some examples, the dimensions of the auxiliary device 200 may be adjusted according to different working condition requirements.

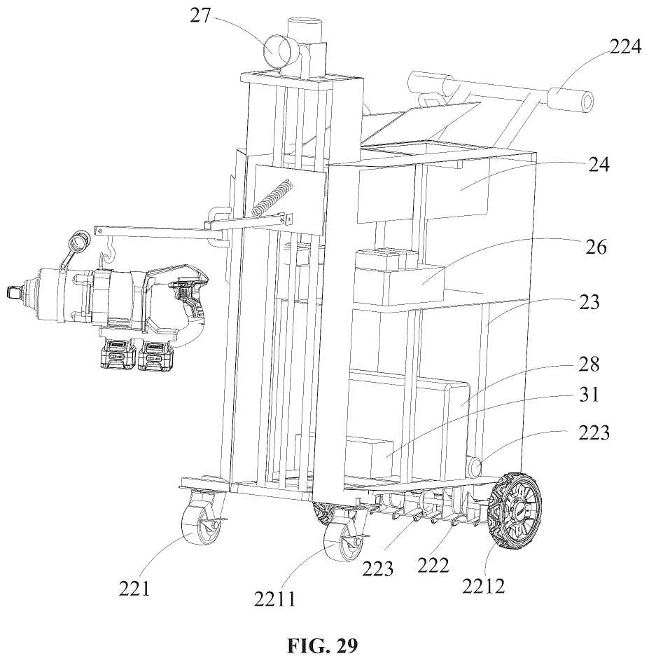

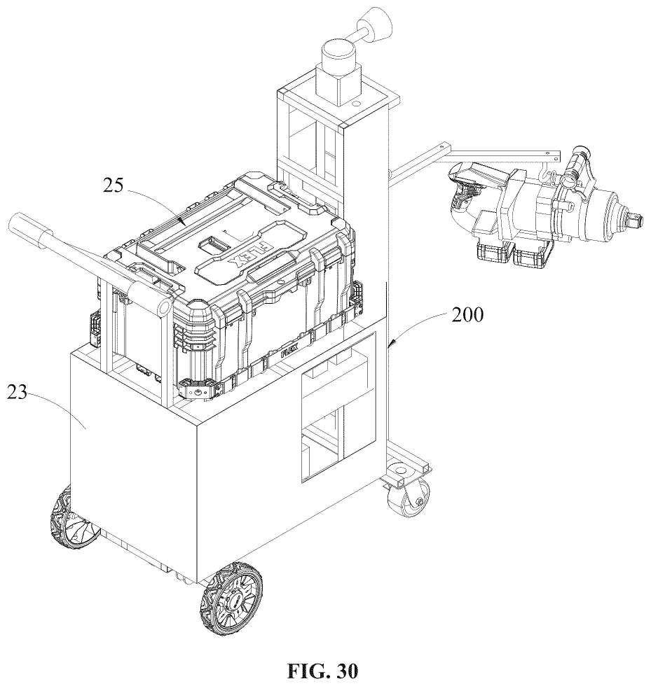

This example further provides a power tool combination as shown in FIG. 30, which differs from the power tool combination in the example of FIG. 29 in that the auxiliary device 200 further includes a deck box 25 detachably connected to the frame body assembly 23 and located on the outer side of the storage space, where the deck box 25 may be mounted at the top or on the side surface of the frame body assembly 23 and used for storing small tools or the like, thereby increasing the space for storage.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. An impact tool, comprising:
a motor comprising a stator and a rotor, wherein the rotor is formed on or connected to a drive shaft that rotates about a first axis;
an output shaft used for outputting torque and rotating about an output axis;
an impact assembly, wherein the motor is drivingly connected to the impact assembly, the impact assembly is configured to apply an impact force to the output shaft, the impact assembly comprises an impact block driven by the drive shaft and a hammer anvil for receiving an impact from the impact block, and the output shaft is formed on or connected to the hammer anvil;
a housing extending basically along a direction of the first axis, wherein the motor and the impact assembly are at least partially disposed in the housing;
a first handle disposed at an end of the housing away from the output shaft along the direction of the first axis; and
a direct current (DC) power supply comprising at least two battery packs and supported on the housing wherein, along the direction of the first axis, the DC power supply at least partially overlaps the motor.

2. The impact tool of claim 1, wherein the DC power supply at least partially overlaps the stator of the motor.

3. The impact tool of claim 1, wherein the at least two battery packs are supported on two sides of the housing.

4. The impact tool of claim 3, wherein the at least two battery packs are symmetrically supported on the two sides of the housing with the first axis as a central axis.

5. The impact tool of claim 2, wherein two battery packs of the at least two battery packs at least partially overlap the stator of the motor separately along the direction of the first axis.

6. The impact tool of claim 1, wherein the at least two battery packs are disposed on a lower side of the housing.

7. The impact tool of claim 5, wherein the housing is formed with or connected to power supply mounting portions, the two battery packs enter the power supply mounting portions along a first direction and a second direction, respectively, and an included angle between the first direction and the second direction is greater than 0 degrees.

8. The impact tool of claim 1, wherein the first handle comprises a first opening for accommodating fingers, and the first opening comprises a closed through hole that surrounds the fingers.

9. The impact tool of claim 1, wherein the first handle comprises a first opening for accommodating fingers and a second opening whose opening direction intersects with an opening direction of the first opening.

10. The impact tool of claim 1, wherein the first handle comprises a connection portion and a grip extending along a third direction, and an end of the grip is connected to the housing through the connection portion, and another end of the grip is a free end.

11. The impact tool of claim 10, wherein the first handle is provided with a power switch for turning on and off the motor, and the power switch is disposed on the grip.

12. The impact tool of claim 10, wherein the third direction intersects with the direction of the first axis.

13. The impact tool of claim 1, wherein a nominal capacity of a battery pack of the at least two battery packs is greater than or equal to 5 Ah.

14. The impact tool of claim 1, wherein the housing comprises an output housing and a motor housing, the output housing supports the output shaft, the motor is at least partially supported in the motor housing, the output housing is connected to the motor housing, and a second handle is connected to the output housing.

15. The impact tool of claim 14, wherein at least one of the first handle or the second handle is capable of been adjusted to multiple working positions.

16. An impact tool, comprising:
a motor comprising a drive shaft that rotates about a first axis;
an output shaft used for outputting torque and rotating about an output axis;
an impact assembly, wherein the motor is drivingly connected to the impact assembly, the impact assembly is configured to apply an impact force to the output shaft, the impact assembly comprises an impact block driven by the drive shaft and a hammer anvil for receiving an impact from the impact block, and the output shaft is formed on or connected to the hammer anvil;
a housing extending basically along a direction of the first axis, wherein the motor and the impact assembly are at least partially disposed in the housing;
a first handle disposed at an end of the housing facing away from the output shaft along the direction of the first axis; and
a direct current (DC) power supply supported on the housing and disposed on a left side and/or a right side of the housing wherein, along the direction of the first axis, the DC power supply at least partially overlaps the motor.

17. An impact tool, comprising:
a motor comprising a drive shaft that rotates about a first axis;
an output shaft used for outputting torque and rotating about an output axis;
an impact assembly, wherein the motor is drivingly connected to the impact assembly, the impact assembly is configured to apply an impact force to the output shaft, the impact assembly comprises an impact block driven by the drive shaft and a hammer anvil for receiving an impact from the impact block, and the output shaft is formed on or connected to the hammer anvil;
a housing extending basically along a direction of the first axis, wherein the motor and the impact assembly are at least partially disposed in the housing;
a first handle disposed on the housing, wherein the first handle is provided with a power switch for turning on and off the motor; and
a direct current (DC) power supply comprising at least two battery packs and supported on the housing wherein, along the direction of the first axis, the first handle at least partially overlaps the DC power supply.

18. The impact tool of claim 17, wherein the first handle further comprises a grip, the power switch is disposed on the grip, the grip is provided with a grip part on a lower side of the power switch, and along the direction of the first axis, the grip part at least partially overlaps the DC power supply.

19. The impact tool of claim 17, wherein the at least two battery packs are symmetrically supported on two sides of the housing with the first axis as a central axis.

20. The impact tool of claim 17, wherein the motor comprises a stator and a rotor, the rotor is formed on or connected to the drive shaft that rotates about the first axis, and the at least two battery packs are behind the stator.
